(19) United States
(12) Patent Application Publication
(10) Pub. No.: US 2026/0197056 A1
(43) Pub. Date: Jul. 9, 2026

(54) UL PRECODER INDICATION FOR RECIPROCITY-BASED UL TRANSMISSIONS

(71) Applicant: Samsung Electronics Co., Ltd., Suwon-si (KR)

(72) Inventors: Gilwon Lee, Prosper, TX (US); Md. Saifur Rahman, Plano, TX (US); Eko Onggosanusi, Coppell, TX (US); Dalin Zhu, Allen, TX (US)

(21) Appl. No.: 19/418,893

(22) Filed: Dec. 12, 2025

Related U.S. Application Data
(60) Provisional application No. 63/742,753, filed on Jan. 7, 2025.

(51) Int. Cl. H04B 7/06

(52) U.S. Cl. CPC H04B 7/0626; H04B 7/0639; H04B 7/06966

(57) ABSTRACT

Apparatuses and methods for uplink (UL) precoder indication for reciprocity-based transmissions. A method performed by a user equipment (UE) includes receiving a downlink reference signal (DL RS) related to a channel state information (CSI) report, measuring the DL RS, and determining a first uplink (UL) precoder based on the measurement. The method includes transmitting the CSI report including information related to the first UL precoder and receiving an UL grant for an UL transmission. The UL grant includes a flag. The flag indicates whether the UL transmission is based on the first UL precoder.

### CROSS-REFERENCE TO RELATED AND CLAIM OF PRIORITY

The present application claims priority under 35 U.S.C. § 119 (e) to: U.S. Provisional Patent Application No. 63/742,753 filed Jan. 7, 2025, which is hereby incorporated by reference in its entirety.

### TECHNICAL FIELD

The present disclosure relates generally to wireless communication systems and, more specifically, to uplink (UL) precoder indication for reciprocity-based transmissions.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL precoder indication for reciprocity-based transmissions.

In one embodiment, a user equipment (UE) is provided. The UE includes a transceiver configured to receive a downlink reference signal (DL RS) related to a channel state information (CSI) report and a processor operably coupled to the transceiver. The processor is configured to measure the DL RS, and determine a first uplink (UL) precoder based on the measurement. The transceiver is further configured to transmit the CSI report including information related to the first UL precoder and receive an UL grant for an UL transmission. The UL grant includes a flag. The flag indicates whether the UL transmission is based on the first UL precoder.

In another embodiment, a base station (BS) is provided. The BS includes a processor and a transceiver operably coupled to the processor. The transceiver is configured to transmit, to a UE, a DL RS related to a CSI report, receive the CSI report including information related to a first UL precoder associated with the DL RS, and transmit an UL grant for an UL reception. The UL grant includes a flag. The flag indicates whether the UL reception is based on the first UL precoder.

In yet another embodiment, a method performed by a UE is provided. The method includes receiving a DL RS related to a CSI report, measuring the DL RS, and determining a first UL precoder based on the measurement. The method includes transmitting the CSI report including information related to the first UL precoder and receiving an UL grant for an UL transmission. The UL grant includes a flag. The flag indicates whether the UL transmission is based on the first UL precoder.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates examples of transmit-receive points that can be used in an open radio access network (O-RAN) NW architecture according to embodiments of the present disclosure;

FIG. 7 illustrates an example of functionality split among O-RAN entities for DL and UL operations according to embodiments of the present disclosure;

FIG. 8 illustrates an example of UL performance in coverage/interference-limited scenarios according to embodiments of the present disclosure;

FIG. 9 illustrates an example of antenna port layouts at the UE according to embodiments of the present disclosure;

FIG. 10 illustrates another example of antenna port layouts at the UE according to embodiments of the present disclosure;

FIG. 11 illustrates yet another example of antenna port layouts at the UE according to embodiments of the present disclosure;

FIG. 12 illustrates an example of DL RS configuration for UL CSI according to embodiments of the present disclosure;

FIG. 13 illustrates an example of a flow diagram for determining a report quantity according to embodiments of the present disclosure;

FIG. 14 illustrates example an example of utilizing a layer quality report according to embodiments of the present disclosure;

FIG. 15 illustrates an example an example of a flow diagram of a UL-TX scheme according to embodiments of the present disclosure;

FIG. 16 illustrates an example of determining a UL report according to embodiments of the present disclosure;

FIG. 17 illustrates an example of a matrix used for SB reporting according to embodiments of the present disclosure;

FIG. 18 illustrates another example of determining a UL report according to embodiments of the present disclosure;

FIG. 19 illustrates an example of indicating a flag via a new UL DCI field according to embodiments of the present disclosure;

FIG. 20 illustrates an example of indicating a flag via an existing UL DCI field according to embodiments of the present disclosure;

FIG. 21 illustrates another example of indicating a flag via an existing UL DCI field according to embodiments of the present disclosure;

FIG. 22 illustrates yet another example of indicating a flag via an existing UL DCI field according to embodiments of the present disclosure;

FIG. 23 illustrates still another example of indicating a flag via an existing UL DCI field according to embodiments of the present disclosure;

FIG. 24 illustrates an example of indicating a flag via a joint indicator according to embodiments of the present disclosure;

FIG. 25 illustrates another example of indicating a flag via a joint indicator according to embodiments of the present disclosure;

FIG. 26 illustrates an example procedure for fallback according to embodiments of the present disclosure; and

FIG. 27 illustrates an example method performed by a UE in a wireless communication system according to embodiments of the present disclosure.

### DETAILED DESCRIPTION

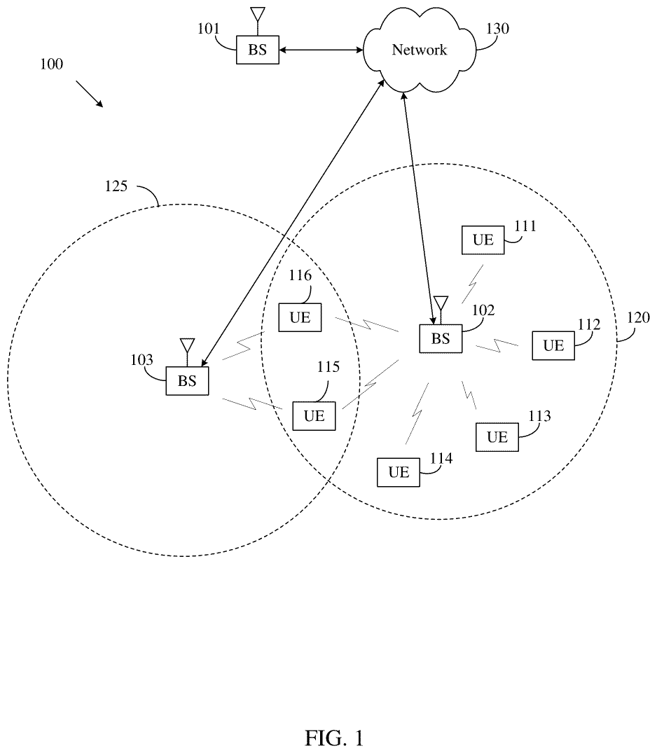

FIGS. 1-27 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v18.0.1, “E-UTRA, Physical channels and modulation;” [REF 2] 3GPP TS 36.212 v18.1.0, “E-UTRA, Multiplexing and Channel coding;” [REF 3] 3GPP TS 36.213 v18.3.0, “E-UTRA, Physical Layer Procedures;” [REF 4] 3GPP TS 36.321 v18.3.0, “E-UTRA, Medium Access Control (MAC) protocol specification;” [REF 5] 3GPP TS 36.331 v18.4.0, “E-UTRA, Radio Resource Control (RRC) Protocol Specification;” [REF 6] 3GPP TS 38.331 v18.4.0, “E-UTRA, NR, Radio Resource Control (RRC) Protocol Specification;” [REF 7] 3GPP TS 38.212 v18.4.0, “E-UTRA, NR, Multiplexing and Channel coding;” [REF 8] 3GPP TS 38.213 v18.4.0, “E-UTRA, NR, Physical layer procedures for control;” [REF 9] 3GPP TS 38.214 v18.4.0, “E-UTRA, NR, Physical layer procedures for data;” [REF 10] 3GPP TS 38.211 v18.4.0, “E-UTRA, NR, Physical channels and modulation;” [REF 11] O-RAN.WG4.CONF.0-R003-v09.00, “O-RAN Working Group 4 (Fronthaul Working Group) Conformance Test Specification;” [REF 12] O-RAN.WG4.CUS.0-R003-v13.00, “O-RAN Working Group 4 (Open Fronthaul Interfaces WG)-Control, User and Synchronization Plane Specification;” and [REF 13] 3GPP TS 38.321 v18.4.0, “E-UTRA, NR, Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for UL precoder indication for reciprocity-based transmission. In certain embodiments, one or more of the BSs 101-103 include circuitry, programing, or a combination thereof to support UL precoder indication for reciprocity-based transmissions.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

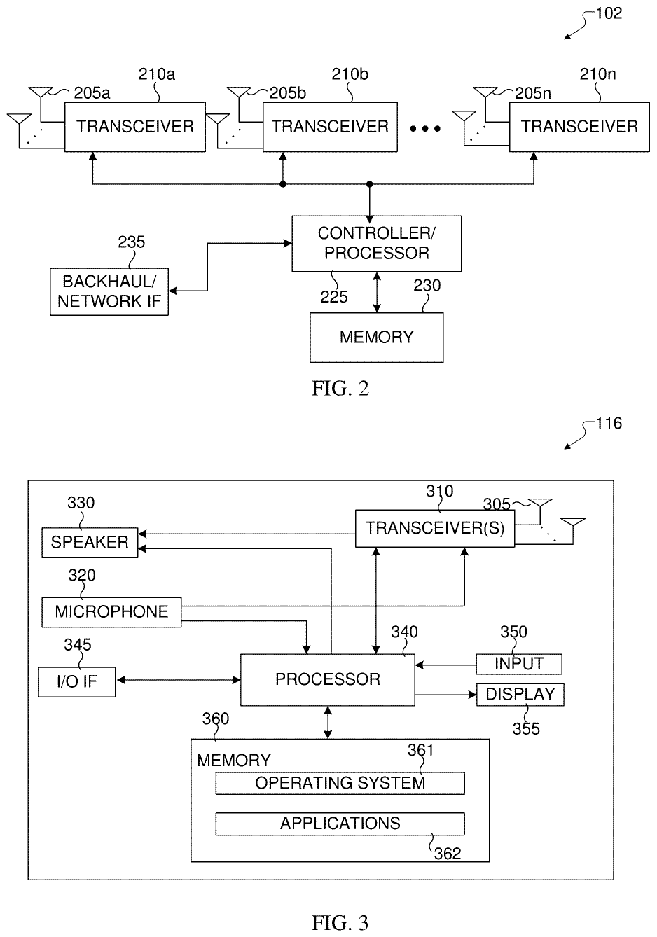

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for CSI configurations in TDD scenarios. Any of a wide variety of other functions could be supported in the gNB 102 by the controller/processor 225.

The controller/processor 225 is also capable of executing programs and other processes resident in the memory 230, such as processes to support UL precoder indication for reciprocity-based transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UL precoder indication for reciprocity-based transmissions as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

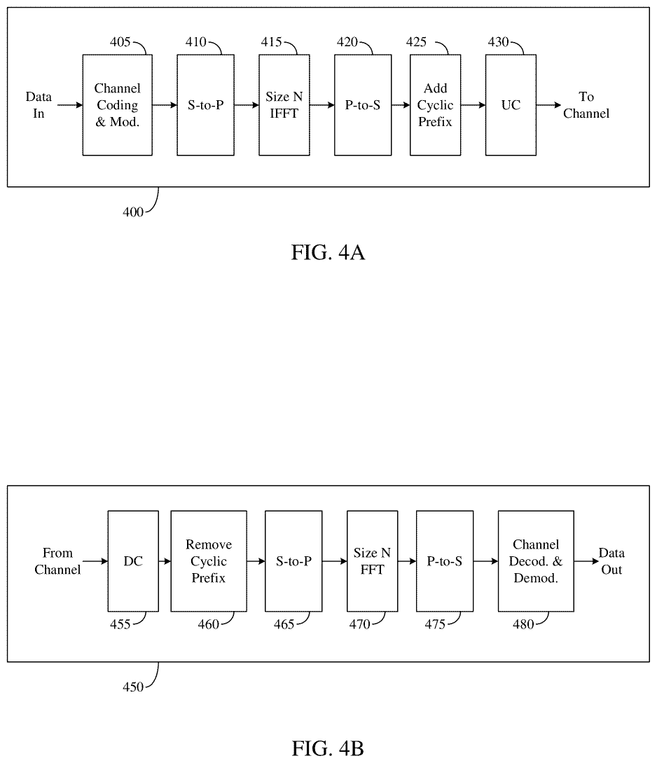

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for UL precoder indication for reciprocity-based transmissions as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown below Error! Reference source not found. Whenever the FR2 is referred, both FR2-1 and FR2-2 frequency sub-ranges shall be considered, unless otherwise stated.

TABLE 1
Definition of frequency ranges

| Frequency range designation | | Corresponding frequency range |
|---|---|---|
| FR1 | | 410 MHz-7125 MHz |
| FR2 | FR2-1 | 24250 MHz-52600 MHz |
| | FR2-2 | 52600 MHz-71000 MHz |

In next generation cellular standards (e.g. 6G), in addition to FR1 and FR2, new carrier frequency bands can be considered, e.g. terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g. up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across all antenna ports is possible.

The 3GPP specification (such as 4G LTE and 5G NR) supports up to 32 CSI-RS antenna ports which enable an eNB (or gNB) to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase. For UL transmission, the 3GPP specification supports 1, 2, or 4 SRS antenna ports in one SRS resource, where each SRS antenna port can be mapped to one or multiple antenna elements at the UE.

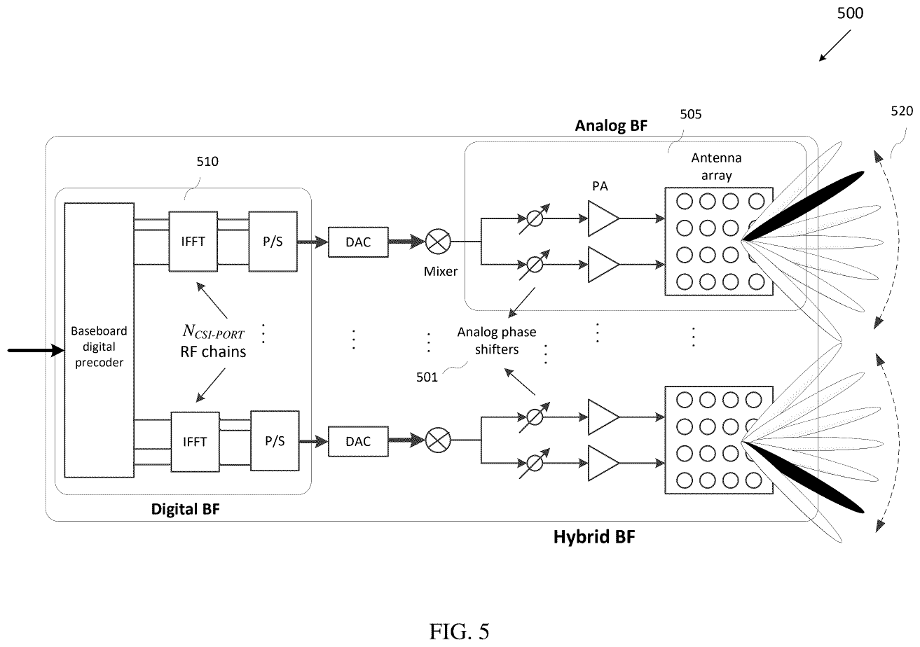

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

In a hybrid analog-digital beamforming, analog beamforming corresponds to a ‘dynamic/varying’ virtualization of multiple antenna elements to obtain one antenna port (or antenna panel). For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed considering carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be possibly non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described above, for low (FR1), high (FR2 and beyond), or mid (6-15 GHz) band, the NW topology/architecture is likely to be more and more distributed in future due to reasons explained above (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

As described above regarding FIG. 5, in one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

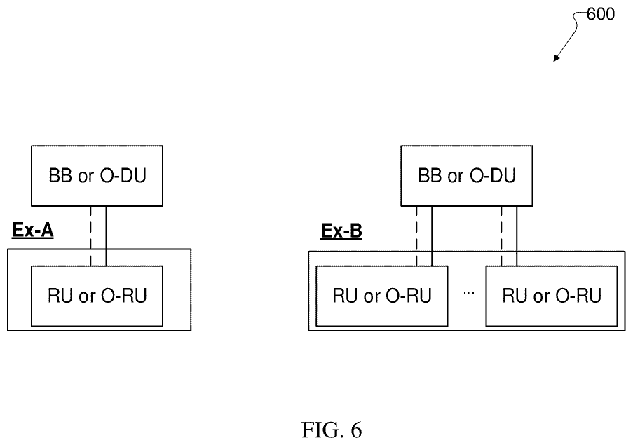

FIG. 6 illustrates examples of transmit-receive points that can be used in an open radio access network (O-RAN) NW architecture 600 according to embodiments of the present disclosure. This example is for illustration only and other embodiments can be used without departing from the scope of the present disclosure.

In an O-RAN NW architecture, a TRP can be functionally equivalent to (hence can be replaced with) or is interchangeable with one of more of the following:
One RU or O-RU: a logical node that includes a subset of the eNB/gNB functions (e.g., as listed in clause 4.2 split option 7-2x)
More than one RUs or O-RUs
One or more than one RUs or O-RUs

Two examples are shown in FIG. 6.

The following are defined in [REF11] and [REF12].

| | |
|---|---|
| O-CU | O-RAN Central Unit-a logical node hosting PDCP, |
| | RRC, SDAP and other control functions |
| O-DU | O-RAN Distributed Unit: a logical node hosting |
| | RLC/MAC/High-PHY layers based on a lower layer |
| | functional split. O-DU in addition hosts an M-Plane |
| | instance. |
| O-RU | O-RAN Radio Unit: a logical node hosting Low-PHY |
| | layer and RF processing based on a lower layer |
| | functional split. This is similar to 3GPP’s “TRP” or |
| | “RRH” but more specific in including the Low-PHY |
| | layer (FFT/iFFT, PRACH extraction). O-RU in |
| | addition hosts M-Plane instance. |

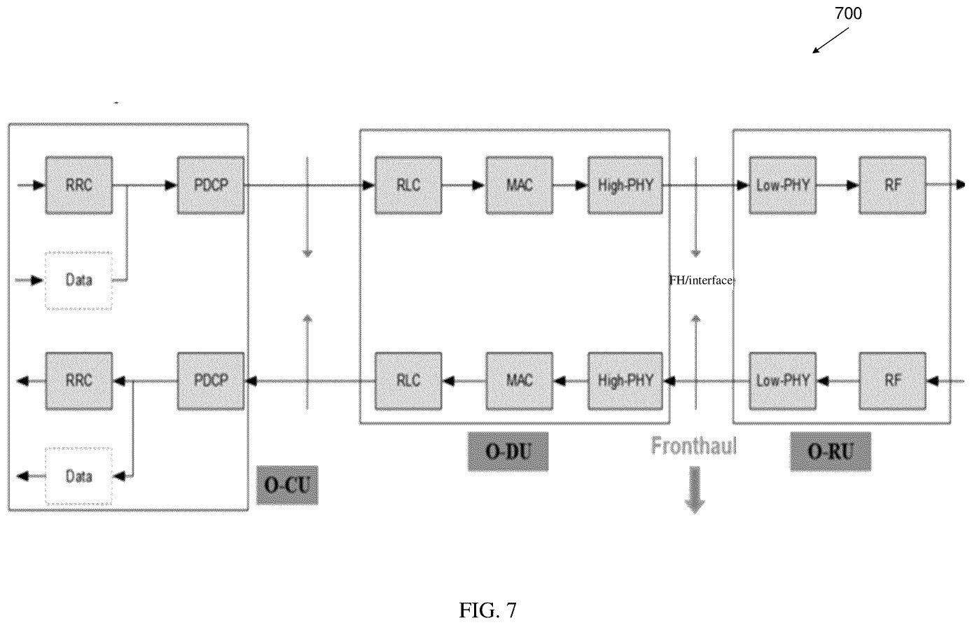

FIG. 7 illustrates an example of functionality split among O-RAN entities for DL and UL operations 700 according to embodiments of the present disclosure. This example is for illustration only and other embodiments can be used without departing from the scope of the present disclosure.

In next-gen MIMO systems (e.g., 6G), at least two aspects need to be considered.
(A) 3GPP PHY specification: The significance of a single NW entity, namely PG (as a collection of ports) in terms of port-common channel properties. This is analogous to the 5G QCL (or TCI state), coherency assumption (e.g., FC, PC, NC).
(B) NW architecture as perceived in O-RAN: The functionality split among O-RAN entities for DL and UL operations, such as O-RU, O-DU, and O-CU (as described above). An example is shown in FIG. 7. In particular, the PHY functionality split between O-DU and O-RU includes at least the following aspects.
   (B1) PHY processing:
      bit-level processing,
      symbol-level processing
   (B2) Scheduling (residing in MAC): SU-MIMO/MU-MIMO scheduling across different O-RUs or/and allocated frequency-domain resources (e.g., PRBs, PRGs, SBs)
      Utilizing UCI carrying CSI
      If DL/UL reciprocity is feasible, also utilizing SRS-based channel measurement
   (B3) Precoder calculation at a gNB (NW side) for DL-SCH transmission:
      For SU-MIMO, precoder can simply follow the PMI (calculated assuming SU-MIMO hypothesis) reported by the UE, or, if DL/UL reciprocity is feasible, be calculated from the eigenvector(s) of the measured DL channels.
      For MU-MIMO, precoder needs to be calculated based on additional orthogonalization (e.g., ZFBF, SLNR) among PMIs, or, if DL/UL reciprocity is feasible, the eigenvectors of the measured channels of the co-scheduled UEs.

The first (A) can be achieved by removing/merging duplicate/redundant abstractions, and simplifying signaling for components of the abstractions. One such framework, namely dynamic MIMO, is proposed in this disclosure, wherein abstractions such as CSI-RS resource, CSI-RS resource set, port, beam, TRP, panel etc. can all be clubbed into one basic entity, namely antenna/port group (PG or O-RU (or RU)), and essential features of PGs are specified. A few essential features discussed include dynamic PG or O-RU (or RU) selection and long-term stats and assumptions across PGs, e.g., quasi co-location (QCL) and coherency relationships across PGs. The proposed framework can also facilitate fast and accurate CSI acquisition, where the CSI can be beam-related (e.g., beam indicator, beam metric), non-beam-related (e.g., RI/PMI/CQI), or both. Additionally, the concept of a cell is replaced with PGs that are distributed through the NW. The mobility can be handled via the PG or O-RU (or RU) selection/update (from one set of PGs to another set of PGs).

A few relevant (more-probable) candidates discussed in the O-RAN Alliance (depicted in FIG. 7) are shown in Table 2.

TABLE 2
(both DL and UL)

| | | | | | | | |
|---|---|---|---|---|---|---|---|
| | | | Hi- | Low- | | | |
| PDCP | RLC | MAC | PHY | PHY | RF | HLS | LLS |

| | | | | | |
|---|---|---|---|---|---|
| O-RAN¹ (Opt7-2x) | O-CU: PDCP | O-DU: RLC, MAC, Hi-PHY | O-RU: Low-PHY, RF | Y | symbol-level PHY |
| Opt7-3 | O-CU: PDCP | O-DU: RLC, MAC, Hi-PHY | O-RU: Low-PHY, RF | Y | bit-level PHY |

| | | | | |
|---|---|---|---|---|
| Opt8 | DU: RLC, MAC, PHY | RU: RF | Y | CPRI |

O-RAN: [REF 12]
Cat-A, Cat-B
UL: Cat-C

While the O-RAN Alliance is intended for 5G NR, it is expected that its framework will continue, or at most refined, for 6G. The O-RAN Alliance specifies 3 levels of functional splits-namely CU, DU, and RU—to facilitate multi-vendor inter-operability within a NW. The manner in which PHY-layer functions are split between DU and RU(s) imposes serious impact on the feasibility, performance, and complexity of different MIMO schemes-mainly due to the latency and quantization loss incurred by the O-RAN-standardized RU-DU interface.

Embodiments of the present disclosure recognize that in NR, two transmission schemes are supported for PUSCH: codebook-based transmission and non-codebook-based transmission. The UE is configured with codebook-based transmission when the higher layer parameter txConfig in pusch-Config is set to ‘codebook’, the UE is configured non-codebook-based transmission when the higher layer parameter txConfig is set to ‘nonCodebook’.

According to Section 6.1.1.1 [REF9], the following is supported for codebook-based UL transmission.

For codebook-based transmission, PUSCH can be scheduled by DCI format 0_0, DCI format 0_1, DCI format 0_2 or semi-statically configured to operate according to Clause 6.1.2.3 [REF9]. If this PUSCH is scheduled by DCI format 0_1, DCI format 0_2, or semi-statically configured to operate according to Clause 6.1.2.3 [REF9], the UE determines its PUSCH transmission precoder based on SRI, TPMI and the transmission rank, where the SRI, TPMI and the transmission rank are given by DCI fields of SRS resource indicator and Precoding information and number of layers in clause 7.3.1.1.2 and 7.3.1.1.3 of [REF5] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, TS 38.211]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI.

For codebook based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fully AndPartialAndNonCoherent’, or ‘partialAndNonCoherent’, or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

For codebook based transmission, only one SRS resource can be indicated based on the SRI from within the SRS resource set. Except when higher layer parameter ul-FullPowerTransmission is set to ‘fullpowerMode2’, the maximum number of configured SRS resources for codebook based transmission is 2. If aperiodic SRS is configured for a UE, the SRS request field in DCI triggers the transmission of aperiodic SRS resources.

The UE shall transmit PUSCH using the same antenna port(s) as the SRS port(s) in the SRS resource indicated by the DCI format 0_1 or 0_2 or by configuredGrantConfig according to clause 6.1.2.3.

The DM-RS antenna ports {\tilde{p}₀, . . . , \tilde{p}ᵥ₋₁} in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

In the rest of the disclosure, ‘fullAndPartialAndNonCoherent’, ‘partialAndNonCoherent’, and ‘Non-Coherent’ are referred to codebookSubsets depending on three coherence type/capability, where the term ‘coherence’ implies all or a subset of antenna ports at the UE that can be used to transmit a layer coherently. In particular,
the term ‘full-coherence’ (FC) implies all antenna ports at the UE that can be used to transmit a layer coherently.
the term ‘partial-coherence’ (PC) implies a subset (at least two but less than all) of antenna ports at the UE that can be used to transmit a layer coherently.
the term ‘non-coherence’ (NC) implies only one antenna port at the UE that can be used to transmit a layer.

When the UE is configured with codebookSubset=‘fullAndPartialAndNonCoherent’, the UL codebook includes all three types (FC, PC, NC) of precoding matrices; when the UE is configured with codebookSubset=‘partialAndNonCoherent’, the UL codebook includes two types (PC, NC) of precoding matrices; and when the UE is configured with codebookSubset=‘nonCoherent’, the UL codebook includes only one type (NC) of precoding matrices.

According to Section 6.3.1.5 of REF7, for non-codebook-based UL transmission, the precoding matrix W equals the identity matrix. For codebook-based UL transmission, the precoding matrix W is given by W=1 for single-layer transmission on a single antenna port, otherwise by Table 3 to Table 8, which are copied below.

The rank (or number of layers) and the corresponding precoding matrix Ware indicated to the UE using TRI and TPMI, respectively. In one example, this indication is joint via a field ‘Precoding information and number of layers’ in DCI, e.g., using DCI format 0_1. In another example, this indication is via higher layer RRC signaling. In one example, the mapping between a field ‘Precoding information and number of layers’ and TRI/TPMI is according to Section 7.3.1.1.2 of [REF10].

TABLE 3
Precoding matrix W for single-layer transmission using two antenna ports

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 4
Precoding matrix W for single-layer transmission using four antenna ports with
transform precoding disabled

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 6-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 5
Precoding matrix W for two-layer transmission using two antenna ports
with transform precoding disabled

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 6
Precoding matrix W for two-layer transmission using four antenna ports
with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 7
Precoding matrix W for three-layer transmission using four antenna ports
with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 8
Precoding matrix W for four-layer transmission using four antenna ports
with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The subset of TPMI indices for the three coherence types are summarized in Table 9 and Table 10, where rank=r corresponds to (and is equivalent to) r layers.

TABLE 9
Total power of precoding matrix W for 2 antenna ports

| | Non-Coherent (NC) TPMIs | | Full-Coherent (FC) TPMIs | |
|---|---|---|---|---|
| Rank | TPMI indices | Total power | TPMI indices | Total power |
| 1 | 0-1 | ½ | 2-5 | 1 |
| 2 | 0 | 1 | 1-2 | 1 |

TABLE 10
Total power of precoding matrix Wfor 4 antenna ports

| | Non-Coherent | | Partial-Coherent | | Full-Coherent | |
|---|---|---|---|---|---|---|
| | (NC) TPMIs | | (PC) TPMIs | | (FC) TPMIs | |
| | TPMI | Total | TPMI | Total | TPMI | Total |
| Rank | indices | power | indices | power | indices | power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 11 and Table 12.

TABLE 11
TPMI indices for codebookSubsets for 2 antenna ports

| Rank | Non-Coherent | fullAndPartialAndNonCoherent |
|---|---|---|
| 1 | 0-1 | 0-5 |
| 2 | 0 | 0-2 |

TABLE 12
TPMI indices for codebookSubsets for 4 antenna ports

| Rank | Non-Coherent | partialAndNonCoherent | fullAndPartialAndNonCoherent |
|---|---|---|---|
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

In up to Rel. 17 NR, for UL transmission, the 3GPP specification supports 1, 2, or 4 SRS antenna ports in one SRS resource. In Rel. 18, the number of SRS antenna ports can be 8, targeting devices such as CPE, FWA, and vehicular UEs. For commercial handheld devices (UEs), for example the smart phones in the current market, are generally restricted by 2Tx chains (or antenna ports). Even though 4 Tx chains (or antenna ports) are supported in Rel. 15 NR, 4 Tx chains are not likely to be applied in the commercial handheld UEs in the near future due to various commercial factors, including the PA cost and limited size of commercial cell phones. However, the advanced or next/future generation of smartphones are (or likely to be) capable of supporting 3 Tx chains in one same frequency band, if feasible, this can boost the UL throughput significantly. In Rel. 19, UL based on 3 antenna ports is supported.

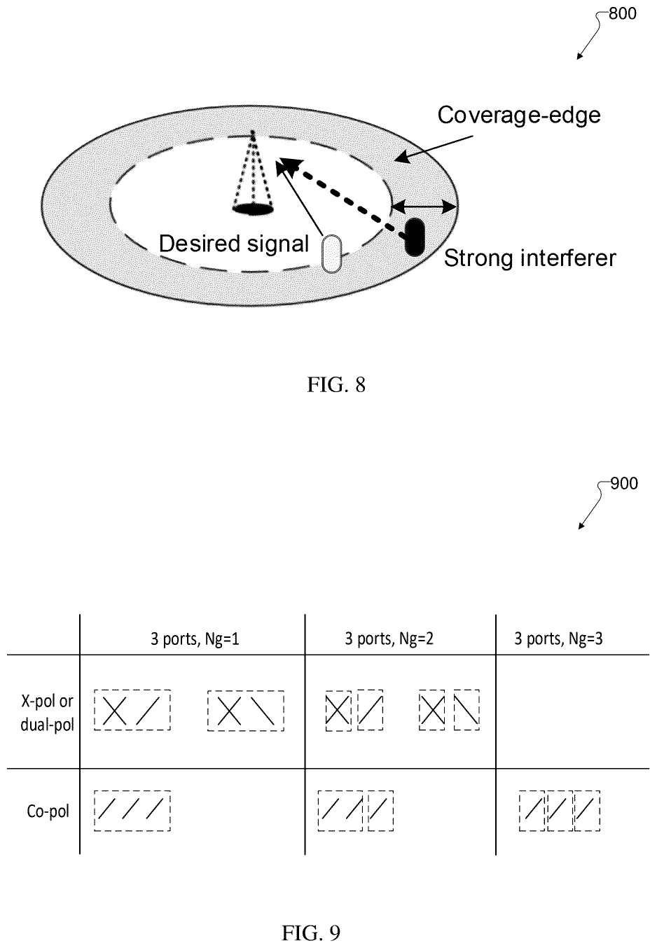

FIG. 8 illustrates an example of UL performance in coverage/interference-limited scenarios 2100 according to embodiments of the present disclosure. This example is for illustration only and other embodiments can be used without departing from the scope of the present disclosure.

UL performance in coverage/interference-limited scenarios remains a critical issue in 5G deployments. For example, a coverage-edge (CE) UE, as shown in FIG. 8, experiences a significant degradation (e.g., 1/100) in UL performance when compared with a reference (idea) UL performance. The same UE on the hand experiences a moderate degradation (e.g., 1/10) in DL performance. The UL SINR

$$\frac{S}{I + N}$$

is low at coverage-edge, que to strong UL interference (I) and (relative to I) weak desired signal(S). Relying on SRS for (i) determining S is inaccurate/erroneous due to the presence of strong I, but (ii) determining I is perfectly fine (since/is anyway strong). Therefore, alternative methods for acquiring accurate UL signal S in interference-limited scenarios are needed in order to improve the accuracy of UL SINR calculation (thereby improving UL link adaptation).

When 4G and 5G deployments are compared, UL coverage remains a bottleneck in both systems, although 5G DL is significantly better than 4G LTE. Implying, gap between DL and UL performance widens in 5G when compared with 4G. Going into 6G, this gap can widen further if UL coverage issue is not addressed. Therefore, 6G UL MIMO should provide solution(s) to this critical issue. In particular, solution(s) should target scenarios where accurate UL-CSI is unavailable at the gNB (due to poor UL SNR, or when UL interference is high).

This disclosure provides several example UL MIMO schemes exploiting UL-DL reciprocity, where DL RS (e.g., CSI-RS) is utilized by the UE to provide UL-CSI estimation for TDD scenarios. The schemes exploit the fact that unlike UL RS, e.g., SRS (which has accuracy issues due to poor UL coverage), DL RS (e.g., CSI-RS) doesn't suffer from the same interference issue for signal S measurement. Thus, the solution can be based on the use of CSI-RS for signal S measurement (included in a UE report) and the use of SRS for interference/measurement at the NW.

The scope of the disclosure is not limited to embodiments or examples herein but includes their extensions or combinations. Further, example schemes or solutions proposed in this disclosure can also be used for DL, or sidelink (SL).

The present disclosure relates to reciprocity-based UL transmission. Aspects include:
UL-related report includes UL TPMI or DL CSI.
ACK or confirmation or a flag information in UL-DCI to indicate whether or not the UE uses/designs UL precoder associated with the UL TPMI of the (latest) UL-related reported
Signaling details

Aspects, features, and advantages of the present disclosure are readily apparent from the following detailed description, simply by illustrating a number of particular embodiments and implementations, including the best mode contemplated for carrying out the present disclosure. Embodiments of the present disclosure also capable of other and different embodiments, and its several details can be modified in various obvious respects, all without departing from the spirit and scope of the present disclosure. Accordingly, the drawings and description are to be regarded as illustrative in nature, and not as restrictive. Embodiments of the present disclosure are illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure covers several components which can be used in conjunction or in combination with one another or can operate as standalone schemes.

FIG. 9 illustrates an example of antenna port layouts at the UE 900 according to embodiments of the present disclosure. This example is for illustration only and other embodiments can be used without departing from the scope of the present disclosure.

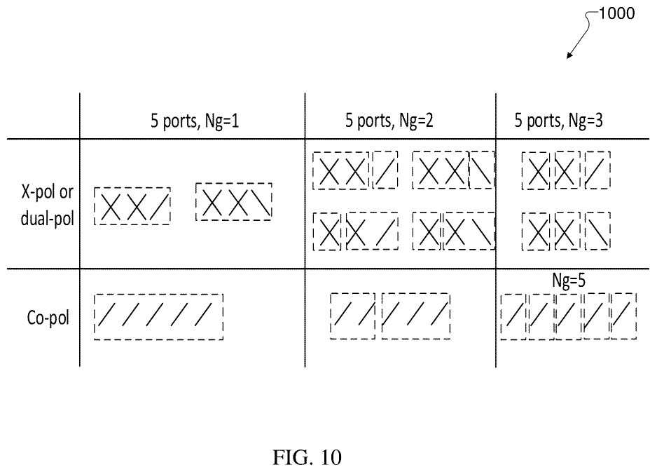

FIG. 10 illustrates another example of antenna port layouts at the UE 1000 according to embodiments of the present disclosure. This example is for illustration only and other embodiments can be used without departing from the scope of the present disclosure.

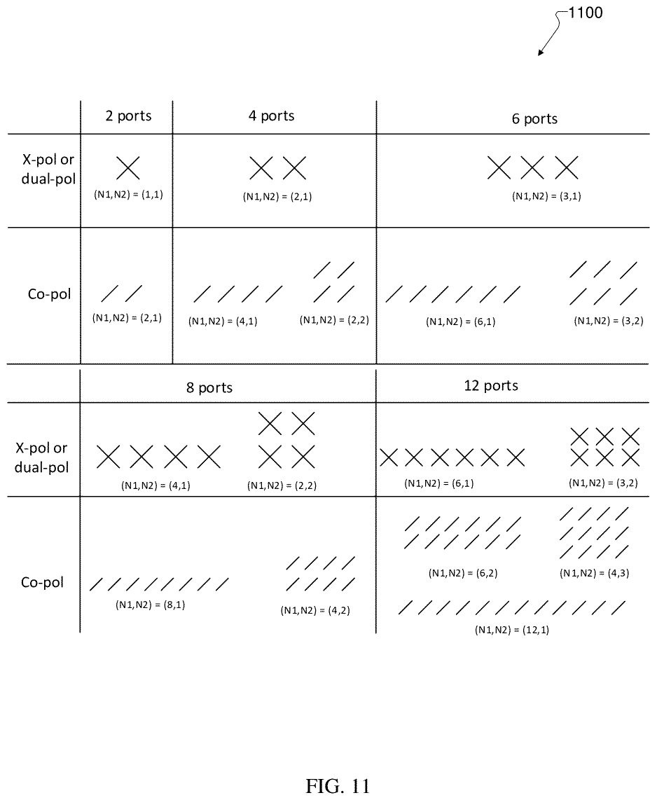

FIG. 11 illustrates yet another example of antenna port layouts at the UE 1100 according to embodiments of the present disclosure. This example is for illustration only and other embodiments can be used without departing from the scope of the present disclosure.

In this disclosure, a UE with even/odd number of antenna ports is considered. We assume all antenna ports of the UE can belong to a single antenna panel or group (i.e., they are co-located, for example, at one plane, side, or edge of the UE) or multiple antenna panels or groups. For a given antenna panel or group, N1 and N2 are the number of antenna ports with the same polarization in the first and second dimensions, respectively. For 2D antenna port layouts, we have N1>1, N2>1, and for 1D antenna port layouts, we either have N1>1 and N2=1 or N2>1 and N1=1. In the rest of the disclosure, 1D antenna port layouts with N1>1 and N2=1 is considered. The disclosure, however, is applicable to the other 1D port layouts with N2>1 and N1=1. Also, in the rest of the disclosure, we assume that N₁>N₂. The disclosure, however, is applicable to the case when N₁<N₂, and the embodiments for N₁>N₂ applies to the case N₁<N₂ by swapping/switching (N₁, N₂) with (N₂, N₁). For a given antenna panel or group, when a (single-polarized) co-polarized antenna port layout, the total number of antenna ports is P=N₁N₂ and when a dual-polarized antenna port layout, the total number of antenna ports is P=2N₁N₂. When the UE has P=3 antenna ports, an illustration of antenna port layouts is shown in FIG. 9. When the UE has P=5 antenna ports, an illustration of antenna port layouts is shown in FIG. 10. An illustration of antenna port layouts for {2, 4, 6, 8, 12} antenna ports at UE is shown in FIG. 11.

Let N_{g} be the number of antenna port groups (panels). For a co-polarized (single polarized) case,
N_{g}=1: one group comprising all antenna ports,
N=2: two groups, one comprising P₁ antenna ports, and another comprising P₂=P−P₁ antenna ports, and
N_{g}=P: P groups, each comprising 1 antenna port.

For a dual-polarized (cross-polarized) case,
N_{g}=1: one group comprising

$$X = ⌊ \frac{P}{2} ⌋$$

cross-pol antenna ports, and P-X single-pol antenna port(s).
N_{g}=2: two groups, one comprising

$${P}_{1} = a ⌊ \frac{P}{2} ⌋$$

cross-pol antenna ports where a E {1, 2, . . . }, and another comprising P₂=P−P₁ single-pol antenna port.

Let s denote the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE refers to SRS antenna ports (either in one SRS resource or across multiple SRS resources).

The UL codebook W for P antenna ports at the UE is based on pre-coding vectors, which can have a structure according to one of the examples in Table 13 depending on whether P if even or odd, and whether the antenna ports are co-polarized or a combination of co-polarized and cross-/dual-polarized.
Ex1A: corresponds to N_{g}=1 with all co-polarized ports.
Ex1B: corresponds to N_{g}=1 with all dual-polarized ports.
Ex2: corresponds to N_{g}=2, 1D antenna layout, P=Pₓ+P_{co} with Pₓ cross-pol ports and P_{co} co-polarized ports.
Ex3: corresponds to N_{g}=2, 2D antenna layout, Pₓ=2N_{x,1}N_{x,2} and P_{co}=N_{co,1}N_{co,2} with Pₓ cross-pol ports and P_{co} co-polarized ports.

TABLE 13
Pre-coding vectors

| | | P is odd | |
|---|---|---|---|
| Ex1A: Co-pol | Ex1B: Dual-pol | Ex2: Co-pol + Dual-pol (1D) | Ex3: Co-pol + Dual-pol (2D) |
| $W = \frac{{w}_{l}}{\sqrt{P}}$ | $W = \frac{1}{\sqrt{P}} {w}_{c ross - pol}$ | $W = \frac{1}{\sqrt{P}} [ \begin{matrix}{w}_{c r o s s - p o l} \\ {w}_{c o - p o l}\end{matrix} ]$ or | $W = \frac{1}{\sqrt{P}} [ \begin{matrix}{w}_{c r o s s - p o l} \\ {w}_{c o - p o l}\end{matrix} ]$ or |
| | ${w}_{c r o s s - p o l} = {v}_{l , n} = [ \begin{matrix}{w}_{l} \\ {φ}_{n} {w}_{l}\end{matrix} ]$ | $\frac{1}{\sqrt{P}} [ \begin{matrix}{w}_{c o - p o l} \\ {w}_{c r o s s - p o l}\end{matrix} ]$ | $\frac{1}{\sqrt{P}} [ \begin{matrix}{w}_{c o - p o l} \\ {w}_{c r o s s - p o l}\end{matrix} ]$ |
| | ${w}_{c r o s s - p o l} = {v}_{l , m , n} = [ \begin{matrix}{v}_{l , m} \\ {φ}_{n} {v}_{l , m}\end{matrix} ]$ | ${w}_{c r o s s - p o l} = {v}_{{l}_{1} , n} = [ \begin{matrix}{w}_{{l}_{1}} \\ {φ}_{n} {w}_{{l}_{1}}\end{matrix} ]$ | ${w}_{c r o s s - p o l} = {v}_{{l}_{1} , m , n} = [ \begin{matrix}{v}_{{l}_{1} , m} \\ {φ}_{n} {v}_{{l}_{1} , m}\end{matrix} ]$ |
| | | w_{co-pol} = wₗ_{₂} | w_{co-pol} = vₗ_{₂}_{,m}_{₂} |

Here, v_{l,m} is a Kronecker product (®) of vectors wₗ and uₘ of lengths N1 and N2, respectively. In one example, wₗ and uₘ are oversampled DFT vectors, i.e.,

$${w}_{l} = [ \begin{matrix}1 & {e}^{j \frac{2 π l}{{O}_{1} {N}_{1}}} & {e}^{j \frac{4 π l}{{O}_{1} {N}_{1}}} & … & {{e}^{j \frac{2 π l ( {N}_{1} - 1 )}{{O}_{1} {N}_{1}}} ]}^{T}\end{matrix}$$

$${u}_{m} \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix} & {N}_{2} > 1 \\ 1 & {N}_{2} = 1\end{matrix}$$

where O₁ and O₂ are oversampling factors in two dimensions, and v_{l,m} is then given by

$${v}_{l , m} = {w}_{l} ⊗ {u}_{m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{{O}_{1} {N}_{1}}_{}}} {u}_{m}\end{matrix} ]}^{T} .$$

In one example, both O₁, O₂ ∈{1,2,4,8}. In one example, O₁ and O₂ can take the same values as Rel. 15 NR Type I codebook (cf. 5.2.2.2.1, TS 38.214), i.e., (O₁, O₂)=(4,4) when N₂>1, and, i.e., (01,02)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g., via higher layer). In one example, (O₁, O₂)=(1,1).

The quantity φₙ is a co-phase for dual-polarized antenna port layouts. In one example, φₙ=e^{jπn/2}, where n∈{0,1,2,3} implying that On belongs to QPSK alphabet {1, j,−1,−j}. In one example, φₙ=e^{j2πn/Z}, where n∈{0,1,2, . . . . Z−1} implying that φₙ belongs to Z-PSK alphabet.

In one example, the values of N₁ and N₂ are configured, e.g., with the higher layer parameter. A few examples of (N₁, N₂) for a given number of antenna ports (P) and antenna layout (co-pol or/and cross-pol) is given in Table 14. The notation Nab where a∈{co, x} and b∈{1,2} is used to denote a number of a-polarized antenna ports in the b-th dimension, respectively.

TABLE 14
Configurations of (N₁, N₂)

| | | | Co-Pol + Dual-pol |
|---|---|---|---|
| Number of | Co-pol | Dual-pol | {(N_{co,1}, N_{co,2}), |
| antenna ports, P | (N_{co,1}, N_{co,2}) | (N_{x,1}, N_{x,2}) | (N_{x,1}, Nₓ [symbol] |
| 1 | (1,1) | | |
| 2 | (2,1), (1,2) | (1,1) | |
| 3 | (3,1), (1,3) | | {(1,1), (1,1)} |
| 4 | (4,1), (1,4), | (2,1) | {(2,1), (1,1)} |
| | (2,2) | | {(1,2), (1,1)} |
| 5 | (5,1), (1,5) | | {(3,1), (1,1)} |
| | | | {(1,3), (1,1)} |
| | | | {(1,1), (2,1)} |
| 6 | (2,3), (3,2), | (3,1) | {(4,1), (1,1)} |
| | (6,1), (1,6) | | {(1,4), (1,1)} |
| | | | {(2,2), (1,1)} |
| | | | {(2,1), (2,1)} |
| | | | {(1,2), (2,1)} |
| 7 | (7,1), (1,7) | | {(5,1), (1,1)} |
| | | | {(1,5), (1,1)} |
| | | | {(3,1), (2,1)} |
| | | | {(1,3), (2,1)} |
| | | | {(1,1), (3,1)} |
| 8 | (8,1), (1,8), | (2,2), (4,1) | |
| | (4,2), (2,4) | | |
| 12 | (3,2), (6,1) | (4,3), (6,2), | |
| | | (12,1) | |
| 16 | (4,2), (8,1) | (8,2), (4,4), | |
| | | (16,1) | |

[symbol]

indicates data missing or illegible when filed

In one example, the values of N1 and N2 are fixed for a given number of antenna ports. For example, (N₁, N₂)=(P,1) for co-pol and

$$( \frac{P}{2} , 1 )$$

for dual-pol antenna. In one example, only one (N₁, N₂) is supported for each value of P, where the supported (N₁, N₂) is one of pairs in Table 14.

In one example, P antenna ports can be divided into N_{g} ∈{1, 2, . . . } groups. In one example, each group corresponds to an antenna panel.

In one example, N_{g}=1 corresponds to a single antenna panel. In one example, N_{g}=1 corresponds to a full coherent (FC) UE or FC antenna layout.

In one example, when number of ports in a group is more than one and N_{g}>1, then ports within each group are coherent, whereas ports across two groups are non-coherent (NC). Such antenna port layout can be referred to as a partial coherent (PC) UE or PC antenna layout.

In one example, N_{g}=P corresponds to a non-coherent (NC) UE or NC antenna layout.

In one example, a single-layer (rank 1) UL transmission can be configured to a UE for both cases when transform precoding is enabled (DFT-s-OFDM) or disabled (CP-OFDM).

Let N_{UL} be the number of antenna ports (or number of Tx RF chains associated with UL transmission) at the UE. Let N_{DL} be the number of antenna ports at the gNB (NW). Let H be the DL channel matrix of size N_{UL}×N_{DL} that can be estimated based on a DL RS (e.g., CSI-RS) measurement. When the DL and UL channels are reciprocal (e.g., TDD), then the UL channel matrix can be estimated (based on the DL RS measurement) as H* and has size N_{DL}×N_{UL}. For brevity of notation, the SB index f or subcarrier index k or polarization index p is not included as suffix or prefix on H. However, in general, H=H^{(I)}, where (I) belongs to {(f, r, p), (f, r), (f, p), (f)} to represent one of above four types of channel notations below. In case of SB comprising of multiple subcarriers, we can use

$${H}_{k}^{( I )}$$

to denote the channel for subcarrier k in SB f.

Let H^{(f,r,p)} be the channel associated with the f-th SB, r-th antenna at the UE, and p-th polarization at the gNB. Note that H^{(f,r,p)} is a vector of size

$$\frac{{N}_{D L}}{2}$$

when p∈{0, 1} (i.e., dual-polarized antenna ports at the gNB).

Let H^{(f,r)} be the channel associated with the f-th SB, r-th antenna at the UE, and all antenna ports at the gNB. Note that H^{(f,r)} is a vector of size N_{DL}.

Let H^{(f,p)} be the channel associated with the f-th SB, all antenna ports at the UE, and p-th polarization at the gNB. Note that H^{(f,p)} is a matrix of size

$${N}_{U L} \times \frac{{N}_{D L}}{2}$$

when p∈{0,1}.

Let H(f) be the channel associated with the f-th SB, all antenna ports at the UE, and all antenna ports at the gNB.

The superscript ( )^{H} denotes conjugate transpose, and the superscript ( )^{T} denotes transpose.

For DL channel H, let us define the following:
DEF0: the DL channel is represented using singular value decomposition (SVD) as

$$H \approx {\sum }_{l = 1}^{L} {λ}_{l} {v}_{l} {u}_{l}^{H}$$

where λₗ is a singular value (a non-negative number), vₗ is a left singular vector of length N_{UL} and uₗ is a right singular vector of length N_{DL}. Note that we have L singular vector pairs (uₗ, vₗ).
DEF1: Left (UL) covariance matrix is represented as E_{UL}=HH^{H}. For multiple subcarriers,

$${E}_{U L} = \frac{1}{\vert f \vert} {\sum }_{k ∈ f} ( ( {H}_{k} ) {( {H}_{k} )}^{H} ) .$$

DEF2: Right (DL) covariance matrix is represented as E_{DL}=H^{H}H. For multiple subcarriers,

$${E}_{D L} = \frac{1}{\vert f \vert} {\sum }_{k ∈ f} ( {( {H}_{k} )}^{H} ( {H}_{k} ) ) .$$

DEF3: Left (UL) eigenvectors vₗ are derived using Eigen value decomposition (EVD) of the covariance matrix E_{UL} as

$${E}_{U L} = {\sum }_{l = 1}^{{L}_{U L}} {λ}_{U L , l} {v}_{l} {v}_{l}^{H} ,$$

where λ_{UL,l} is an eigenvalue (a non-negative number).
DEF4: Right (DL) eigenvectors uₗ are derived using EVD of the covariance matrix E_{DL} as

$${E}_{D L} = {\sum }_{l = 1}^{{L}_{D L}} {λ}_{D L , l} {u}_{l} {u}_{l}^{H} ,$$

where λ_{DL,l} is an eigenvalue (a non-negative number).

Note L_{UL}=L_{DL}=v is the rank of the DL or UL covariance matrix and

$${λ}_{U L , l} = {λ}_{D L , l} = {λ}_{l}^{2}$$

is an eigenvalue or \sqrt{λ_{UL,l}}=\sqrt{λ_{DL,l}}=λₗ is a corresponding singular value.

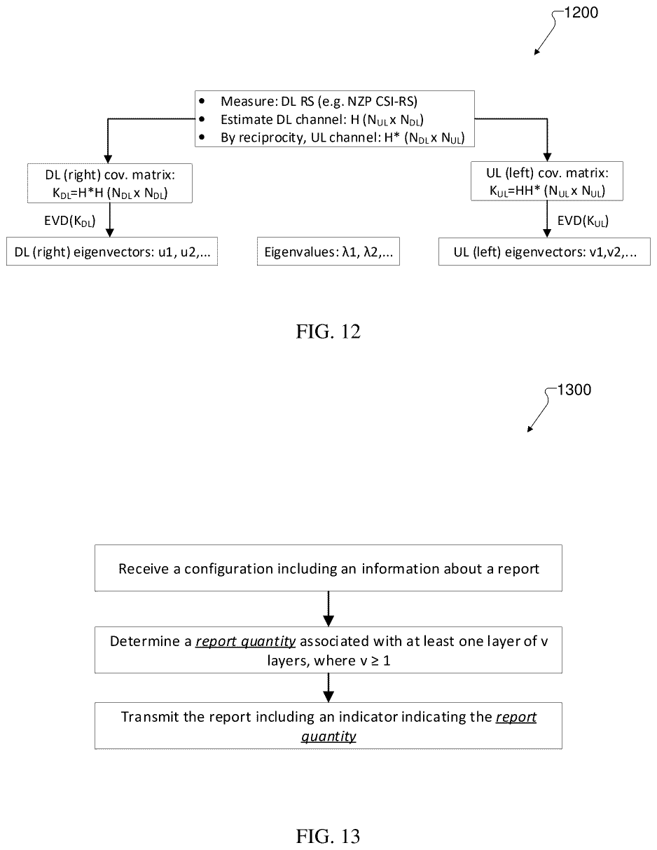

FIG. 12 illustrates an example of DL RS configuration for UL CSI 1200 according to embodiments of the present disclosure. This example is for illustration only and other embodiments can be used without departing from the scope of the present disclosure.

In one embodiment, as shown in FIG. 12, a UE is configured to receive a DL RS (e.g., NZP CSI-RS) for measurement, and in response, the UE measures the DL RS, estimates the DL channel H based on the measurement, and assuming DL and UL channel reciprocity estimates UL channel as H^{H} (Hermitian or conjugate transpose of matrix H). As described above, based on the DL channel H, the UE can also determine the following:
DL (right or transmit) eigenvectors u₁, u₂, . . .
UL (left or receive) eigenvectors v₁, v₂, . . .
Eigenvalues λ₁, λ₂, . . . .

Based on DL and UL channel reciprocity, based on the UL channel H^{H}, the UE can also determine the following:
DL (left or receive) eigenvectors u₁, u₂, . . .
UL (right or transmit) eigenvectors v₁, v₂, . . .
Eigenvalues λ₁, λ₂, . . .

Since right or transmit eigenvectors can be used to pre-code,
for DL precoding, eigenvectors u₁, u₂, . . . can be used, and
for UL precoding, eigenvectors v₁, v₂, . . . can be used.

Note that the strength or quality of a l-th DL or UL layer can be determined based on the corresponding value λₗ.

FIG. 13 illustrates an example of a flow diagram for determining a report quantity 1300 according to embodiments of the present disclosure. This example is for illustration only and other embodiments can be used without departing from the scope of the present disclosure.

In one embodiment, as shown in FIG. 13, a UE receives a configuration or/and an indication (e.g., an RRC message, IE, or parameter, or/and a DCI trigger or codepoint) and in response, determines a report quantity associated with at least one layer of a total of v≥1 layers, where the report includes an indicator indicating the determined report quantity, denoted herein as q. The quantity q provides an information about the strength/quality of the at least one layer.

In one example, the report quantity is UL-related. In one example, the report quantity is DL-related. In one example, the report quantity is both DL-related and UL-related.

When DL-related, the report quantity can be associated with a precoding matrix, and a layer corresponds to a column of the precoding matrix, indicated via the PMI or determined by the UE. The PMI can be included in the CSI report (including RI, CQI, PMI, as described in this disclosure). The quantity q therefore can provide information about the strength/quality of layers corresponding to columns of the precoding matrix.

When UL-related, the report quantity can be associated with an UL precoding matrix, and a layer corresponds to a column of the UL precoding matrix, indicated via the TPMI or determined by the UE. The TPMI can be included in the UL-grant. The quantity q therefore can provide information about the strength/quality of layers corresponding to columns of the UL precoding matrix.

The NW/gNB, upon reception, can utilize the UL-related quantity q to improve/adapt/determine UL link adaptation (e.g., UL SNR or SINR for UL MCS selection) for an upcoming UL transmission (e.g., UL-grant for PUSCH transmission).

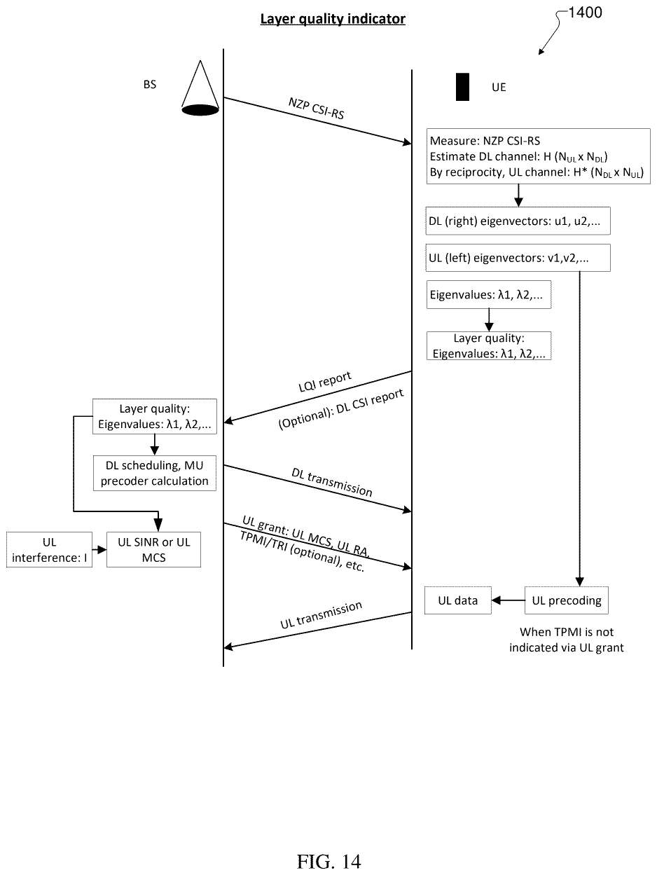

FIG. 14 illustrates an example of utilizing a layer quality report 1400 according to embodiments of the present disclosure. This example is for illustration only and other embodiments can be used without departing from the scope of the present disclosure.

When DL and UL channels are reciprocal (e.g., in TDD scenarios), the report quantity can be for both DL-related and UL-related. This is due to the fact that the layer quality/strength of a layer can be applied to (or associated with) either a DL layer or a corresponding UL layer. An illustration of utilizing layer quality report for the two use cases (mentioned above) is shown in FIG. 14. As shown, the UE based on the DL RS measurement can determine DL (right) and UL (left) eigenvectors and corresponding eigenvalues {(uₗ, vₗ, λₗ)}, report LQI indicating (quantized) eigenvalues {λₗ} or an information about them. The UE can also include DL CSI (e.g., RI, CQI, PMI) in the report. NW/gNB upon receiving the LQI can determine the layer quality, and apply/utilize it for (a) DL scheduling or/and MU precoding calculation for subsequent DL transmission(s), or (b) UL MCS selection to be indicated via an UL-grant for subsequent UL transmission(s). The UL-grant includes UL resource allocation (UL RA), and may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g., 1), or configured via higher layer (e.g., via PUSCH-Config).

In the rest of the disclosure, embodiments and examples are described for schemes utilizing the (UL-related) report quantity for UL transmissions in TDD scenarios (wherein DL-UL reciprocity applies).

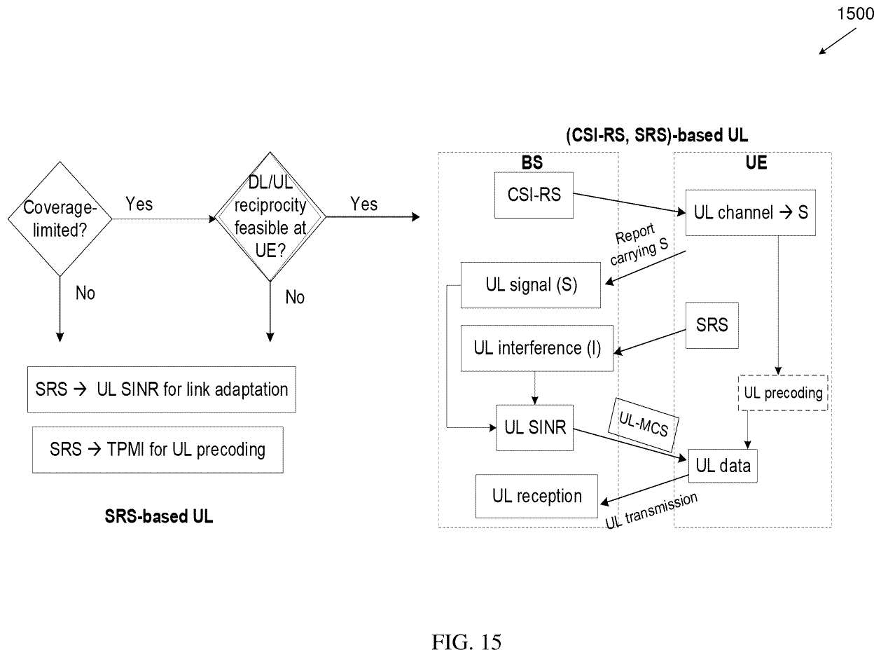

FIG. 15 illustrates an example of a flow diagram of a UL-TX scheme 1500 according to embodiments of the present disclosure. This example is for illustration only and other embodiments can be used without departing from the scope of the present disclosure.

In the following, an UL SINR can be defined as:

$$SINR = \frac{S}{I + N} or as SINR = {\sum }_{k ∈ X} \frac{S ( k )}{I ( k ) + N ( k )}$$

where X is a set of subcarriers.

In one embodiment, as shown in FIG. 15, an UL transmission scheme can be described as follows. When a UE is in coverage, the UL transmission is based on SRS akin to the legacy (traditional) SRS-based UL transmission scheme (where SRS is used for UL SINR as well as UL TPMI). Else, when the UE is located in coverage-limited/-edge region and the DL-UL reciprocity is feasible, the UE is configured with an UL-assisting/-related report, wherein the UE is configured with at least one NZP CSI-RS for acquiring/measuring accurate S (in coverage-limited scenarios), and the UE based on the measurement, determines a report including at least one indicator indicating S. The NW performs UL link adaptation for the UE based on received S and (SRS-based) estimated interference I.

In one example, the report is a high-res report wherein the report corresponds to a direct DL channel explicit feedback (per sub-band). In one example, the report is a low-res report wherein the report corresponds to an L1-RSRP (per sub-band).

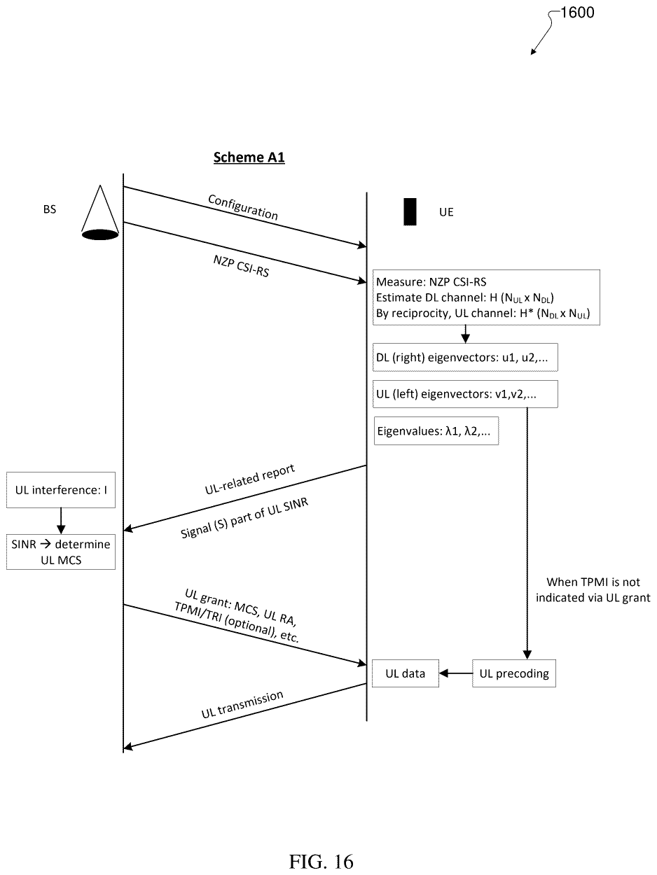

FIG. 16 illustrates an example of determining a UL report 1600 according to embodiments of the present disclosure. This example is for illustration only and other embodiments can be used without departing from the scope of the present disclosure.

In one embodiment, as shown in FIG. 16, a UE receives a configuration or/and indication (e.g., an RRC message, IE, or parameter, or/and a DCI trigger or codepoint) including information about at least one NZP CSI-RS and an UL-related report. The UE, in response, measures the at least one NZP CSI-RS and based on the measurement, determines the UL-related report assuming that UL and DL channels are reciprocal (e.g., for TDD scenarios). The report includes an indicator (or UCI parameter) indicating a signal(S) part/component for UL SINR calculation, where the signal S can be based on eigenvalue(s) λ₁, . . . associated with v≥1 layers, or based on estimated UL channel. The eigenvalue(s) can be based in DL channel estimation (based on the measurement of NZP CSI-RS) as described above.

The NW/gNB, upon reception of the UL-related report, can use the signal S to calculate UL SINR when the UL interference/is available at the NW/gNB. The calculated UL SINR can then be used for UL MCS selection in order to improve UL link adaptation for upcoming UL transmission(s) (e.g., via DCI with UL-grant for PUSCH transmission). The UL-grant includes UL resource allocation (UL RA), i.e., a set of PRBs for UL transmission and the determined UL MCS. The UL-grant may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g., 1), or configured via higher layer (e.g., via PUSCH-Config).

In one example, the signal S part can be calculated/determined according to at least one of the following examples.
In one example, S=∥H_{UL}∥² i.e., square of norm of H_{UL}. The norm of a vector y=[y₁ . . . , y_{Y}] can be defined as

$$‖ y ‖ = \sqrt{{\sum }_{i = 1}^{Y} {abs ( {y}_{i} )}^{2}} .$$

In one example, S=∥H_{UL}P_{UL}∥² where P_{UL} is an UL precoding vector/matrix. In one example, when NW indicates TRI, the UE determines corresponding P_{UL}, but does not report it. In one example, when NW indicates TRI, the UE determines corresponding P_{UL} and reports it. In one example, the UE determines TRI and P_{UL}, and reports TRI only. In one example, the UE determines TRI and P_{UL}, reports both.
In one example, for layer l, the signal part is sₗ=λₗ (eigenvalue). The (per-layer) signal S then is [s₁ . . . sᵥ] (v=rank).
In one example,

$$S = {\sum }_{l = 1}^{υ} {λ}_{l} or \frac{1}{υ} {\sum }_{l = 1}^{υ} {λ}_{l} or {\sum }_{l = 1}^{υ} {λ}_{l}^{2} or \frac{1}{υ} {\sum }_{l = 1}^{υ} {λ}_{l}^{2} .$$

In one example, for a set of subcarriers X, the signal S can be summed (averaged) over X, i.e.,

$$S = {\sum }_{k ∈ X} S ( k ) or \frac{1}{{N}_{X}} {\sum }_{k ∈ X} S ( k )$$

where N_{X} is a number of subcarriers in X and S(k) is according to one of examples above, calculated at subcarrier k in the set X.

In one example, the granularity of the reporting of S in frequency domain (FD) is according to at least one of the following examples.
In one example, the granularity in FD is WB, i.e., one value or multiple values are reported, as described above, and the reported value(s) is for the entire reporting band configured for the reporting. The resolution (number of bits) for this WB reporting can be fixed (e.g., 4 or 5 or 6 or 7 bits), or configured from a candidate set of values, e.g., from {3, 4, . . . , 10}.
In one example, the granularity in FD is SB, i.e., one value or multiple values are reported, as described above, for each SB in the reporting band configured for the reporting. That is, if number of SBs N_{SB}>1, then for each of N_{SB} SBs, one value or multiple values are reported, as described above. This SB reporting can be independent/separate for each SB. Or, it can be differential w.r.t. to a WB value. The number of bits for reporting WB and (differential) SB values can be N_{WB} and N_{SB} where N_{WB}>N_{SB}. In one example, N_{WB} and N_{SB} are fixed. In one example, N_{WB} is configured, and N_{SB} is configured. In one example, N_{WB} is fixed, and N_{SB} is fixed. In one example, N_{WB} and N_{SB} are configured.
In one example, the granularity in FD is PRG-level, where an RBG is a set (number) of consecutive virtual resource blocks.
In one example, the granularity in FD depends on a target UL RA. For example, the number of FD units NED for reporting can be fixed (e.g., 2, 4, 8, or 16) or configured/indicated (via RRC or/and MAC CE or/and DCI). The size of each

$$FD unit = ⌈ \frac{{N}_{U L R A}}{{N}_{F G}} ⌉ or \frac{{N}_{U L R A}}{{N}_{F G}} or ⌊ \frac{{N}_{U L R A}}{{N}_{F G}} ⌋$$

where N_{ULRA} is the number of PRBs in the target UL RA. The target UL RA can be within or included in the measurement BW of NZP CSI-RS.

In one example, the granularity of the reporting of S in spatial domain (SD) is according to at least one of the following examples.
In one example, one value (common across all layers) is reported regardless of number of layers (v).
In one example, one value for each layer is reported, i.e., the indicator indicates v≥1 values, one for each of v layers.
In one example, one value per up to a rank value (e.g., 4) in a CW (of the transport block, TB) is reported, i.e., the indicator indicates one value for each CW. When there are multiple layers associated with (mapped to) a CW, the corresponding value applies to all of the multiple layers. The mapping of layers to CWs can be fixed, or configured (e.g., via RRC or/and DCI) or reported by the UE (e.g., via CSI report over UCI or/and UE capability report). The number of value(s) included in the report can be fixed (e.g., 1 or v or number of CWs), or configured (e.g., via RRC or/and DCI), or reported by the UE (e.g., via CSI report over UCI or/and UE capability report). When reported by the UE, a CSI/UCI part 1 of a two-part CSI/UCI can be used/configured for reporting.
In one example, v layers can be divided into G groups of layers, and the report corresponds to or associated with (or provides information about) one of or a subset of or all of the group of layers, i.e., the indicator indicates one value for a group of layers or one value for each of a subset of or all of the group of layers. When there are multiple layers associated with (mapped to) a group of layers, the corresponding value applies to all of the multiple layers within the group. The mapping of layers to groups of layers can be fixed, or configured (e.g., via RRC or/and DCI) or reported by the UE (e.g., via CSI report over UCI or/and UE capability report). The number of value(s) included in the report can be fixed (e.g., 1 or v or number of CWs), or configured (e.g., via RRC or/and DCI), or reported by the UE (e.g., via CSI report over UCI or/and UE capability report). When reported by the UE, a CSI/UCI part 1 of a two-part CSI/UCI can be used/configured for reporting.

In one example, at least one of the following examples can be used for reporting the value(s).
In one example, the value(s) or square of value(s), i.e., their powers are reported in a linear scale.
In one example, the value(s) or square of value(s), i.e., their powers are reported in a logarithmic scale (e.g., dB). In one example, a value x in the logarithmic scale is given by 10 log₁₀x or 10 log₁₀x²=20 log₁₀ x.
In one example, the value(s) or square of value(s) (in linear or logarithmic scale) are reported in an absolute manner, i.e., independently/separately for each value.
In one example, the value(s) or square of value(s) (in linear or logarithmic scale) are reported in a differential manner.
In one example, when the signal part S is based on eigenvalues, and since eigenvalues are monotonic, non-increasing, i.e., λ₁≥λ₂≥ . . . , we can have S=[σ₁ σ₂ . . . ] where for i=1, σ₁=Q₁(λ₁), a quantized value based on λ₁ and for i>1, σᵢ=Q₂(f(λᵢ₋₁, λᵢ)), a quantized value based on f(λᵢ₋₁, λᵢ) denoting a relative value of λᵢ w.r.t. λᵢ₋₁. Here, Q₁ and Q₂ denote quantizers/codebooks.
   In one example, f(λᵢ₋₁, λᵢ)=λᵢ−λᵢ₋₁. At the receiver, based on received S, value(s) can be represented (reconstructed) as a summation

$${\sum }_{k = 1}^{i} {σ}_{k} .$$

Note that f(λᵢ₋₁, λᵢ)≤0. Hence, Q₂ quantizes zero or negative (i.e., non-positive) values.
In one example,

$$f ( {λ}_{i - 1} , {λ}_{i} ) = \frac{{λ}_{i}}{{λ}_{i - 1}} .$$

At the receiver, based on received S, value(s) can be represented (reconstructed) as a product

$${\prod }_{k = 1}^{i} {σ}_{k} .$$

Note that f(λᵢ₋₁, Aᵢ)≤1.
In one example, when the signal part S is based on eigenvalues, and since eigenvalues are monotonic, non-increasing, i.e., λ₁≥λ₂≥ . . . , we can have S=[σ₁ σ₂ . . . ] where for i=1, σ₁=Q₁(λ₁), a quantized value based on λ₁ and for i>1, σᵢ=−Q₂(f(λᵢ₋₁, λᵢ)), a quantized value based on f(λᵢ₋₁, λᵢ) denoting a relative value of λᵢ w.r.t. λᵢ₋₁. Here, Q₁ and Q₂ denote quantizers/codebooks.
   In one example, f(λᵢ₋₁, λᵢ)=λᵢ₋₁−λᵢ or abs(λᵢ−λᵢ₋₁) (absolute value). At the receiver, based on received S, value(s) can be represented (reconstructed) as a summation

$${\sum }_{k = 1}^{i} {σ}_{k} .$$

Note that f(λᵢ₋₁, λᵢ)≥0. Hence, Q₂ quantizes zero or positive (i.e., non-negative) values.

In one example, for a value range between 0 and 1, the quantizer/codebook in logarithmic scale include values in set

$$\{ \frac{1}{{2}^{\frac{N - q}{s}}} \} or \{ 1 - \frac{1}{{2}^{\frac{N - q}{s}}} \} .$$

In one example, q=0, 1, . . . , N−1. In one example, s∈

$$\{ \frac{1}{2} , \frac{1}{4} \} .$$

In one example, N∈{2,3,4}.

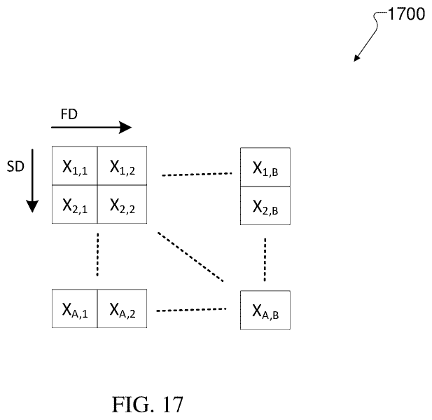

FIG. 17 illustrates an example of a matrix used for SB reporting 1700 according to embodiments of the present disclosure. This example is for illustration only and other embodiments can be used without departing from the scope of the present disclosure.

In one example, for SB reporting, as shown in FIG. 17, S is a A×B matrix, where A and B are number of reported values in SD and FD, respectively. In one example, A=v (number of layers). In one example, B=N_{SB} (number of SBs). In SD, values are monotonic non-increasing, i.e., i.e., X_{1,b}≥X_{2,b}≥ . . . ≥X_{A,b} for any (column) SB index b∈{1, 2, . . . , B}.
In one example, the index (b*) of the strongest/largest value X_{1,b*} (from first (SD) row, {X_{1,1}, X_{1,2}, . . . , X_{1,B}}) is reported, e.g., using ┌log₂ B┐ bits, and the rest of AB−1 values are normalized (divided by X_{1,b*}), before reporting. When B=1, the index (b*) is not reported. The value of X_{1,b*} can be fixed (e.g., 1), or reported.
In one example, AB values are reported independently.

In one example, the metric for reporting S can be according at least one of the following examples.
In one example, the metric corresponds to an RSRP value. In one example, the RSRP values or/and payload (number of bits) for reporting is the same as that for L1-RSRP reporting in 38.214 and 38.212.
In one example, the metric corresponds to power (or square of amplitude) or amplitude value. In one example, the power/amplitude values or/and payload (number of bits) for reporting is the same as that for amplitude reporting in Rel-15 or Rel-16 Type II or enhanced Type II codebook as described in 38.214 and 38.212.
In one example, the metric corresponds to eigenvalues associated with the v “strongest” eigenvectors (with maximum values of eigenvalues) of the measured channel (e.g., DL channel measurement based on NZP CSI-RS). In one example, the eigenvalues or/and payload (number of bits) is the same as that for amplitude reporting in Rel-15 or Rel-16 Type II or enhanced Type II codebook as described in 38.214 and 38.212.

In one example, the at least one NZP CSI-RS or/and the report can be according at least one or a combination of multiple of the following examples.
In one example, the at least one NZP CSI-RS is aperiodic (AP), and the report is also AP. For example, a field (CSI request field) in a DCI (e.g., UL-DCI) can be used to trigger an AP CSI trigger state for the measurement and reporting. The measurement can be in a slot after the slot with the DCI, the slot can be determined based on a slot offset (which can be included in the trigger state definition).
In one example, the at least one NZP CSI-RS is a semi-persistent (SP) and the report is AP. In one example, a SP CSI-RS can be treated as a special case of AP, i.e., AP with K>1 measurement instances or K AP CSI-RSs, with a fixed separation (d) between two measurement instances or measurement RSs. For example, a field (CSI request field) in a DCI (e.g., UL-DCI) can be used to trigger a CSI trigger state with a SP CSI-RS (as described above) for the measurement and reporting. The measurement can be in K slots after the slot with the DCI, the slots can be determined based on a slot offset (which can be included in the trigger state definition). The separation between two consecutive slots d can be fixed (e.g., 1 or 2) or configured (via RRC) or indicates (via DCI, e.g., as part of the CSI trigger state).
In one example, the at least one NZP CSI-RS is periodic (P)/SP NZP CSI-RS and the report is SP. In one example, the SP report is a special case of AP report, i.e., AP with L>1 reporting instances or L AP CSI reports, with a fixed separation (e) between two reporting instances or AP reports. A CSI trigger state can be triggered via a DCI or activated via a MAC CE for the measurement and reporting.
In one example, the at least one NZP CSI-RS is a P-NZP CSI-RS and the report is P-report. This configuration can be RRC-based.
In one example, the at least one NZP CSI-RS can be a CSI-RS for (DL) CSI, without any restriction.
In one example, the at least one NZP CSI-RS can be a CSI-RS for (DL) CSI, but with at least one restriction.
   In one example, the restriction can be based on a number of CSI-RS ports (P) such as P≤t, where t is a threshold. In one example, t can be fixed, e.g., t=number of antenna ports at UE, or t=8 or 16. In one example, t is configured subject to UE capability reporting on the max value P that the UE can support.

In one example, the reporting of the report can be a standalone report (i.e., not multiplexed with any other report or UCI parameter). In one example, the report can be a non-standalone report, hence can be multiplexed together with another report or UCI parameter. When multiplexed with another report or UCI parameter, another report can be a (DL) CSI report and the UCI parameter can be at least one of RI, PMI, CQI, LI, CRI, SSBRI, L1-RSRP, L1-SINR, and TDCP. In one example, the report can be standalone or non-standalone based on configuration (from the NW, e.g., RRC or/and MAC CE or/and DCI) or UE capability. In one example, the report can be a non-standalone report, and is a part of (included in) a (DL) CSI report, where the CSI report can include at least one of RI, PMI, CQI, LI, CRI.

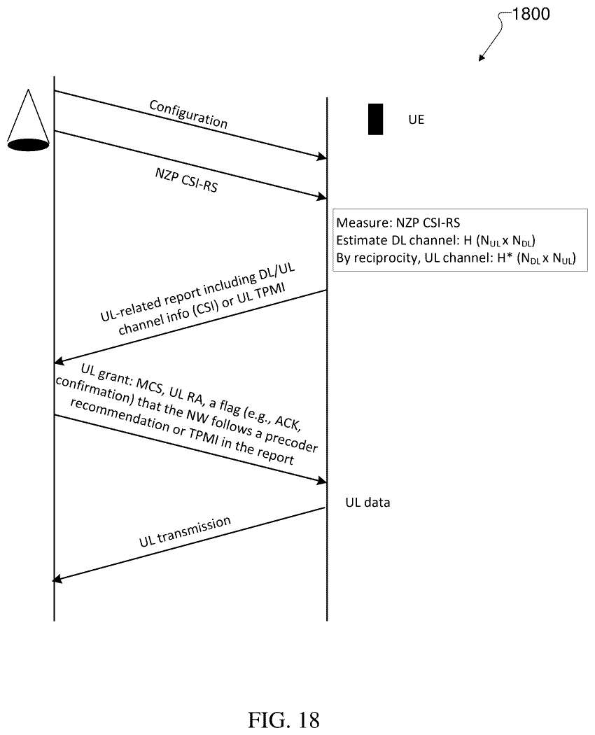

FIG. 18 illustrates another example of determining a UL report 1800 according to embodiments of the present disclosure. This example is for illustration only and other embodiments can be used without departing from the scope of the present disclosure.

In one embodiment, as shown in FIG. 18, a UL-related report includes UL TPMI or CSI (or precoder). For example, UL TPMI or CSI (or precoder) is designed based on a codebook, e.g., a low-resolution codebook (e.g., Rel-19 eType-I CSI codebook) or a high-resolution codebook (e.g., Rel-16 eType-II CSI codebook) or an explicit CSI codebook, e.g., the DL/UL eigenvectors, or other explicit codebook via AI/ML methods. In one example, the CSI includes DL precoder information. In one example, the CSI includes UL precoder information (i.e., UL TPMI). In one example, the CSI includes both DL and UL precoder information.

Depending on a situation or a decision from the NW/gNB, the NW transmits a UL grant (UL-DCI) including a flag (e.g., ACK, or confirmation) that the NW follows a precoder recommendation associated with the reported CSI (or UL TPMI) from the UE. FIG. 18 shows an example of the embodiment. In one example, the flag indicates the NW follows a precoder recommendation associated with the reported CSI, i.e., the UE designs a UL precoder according to the precoder recommendation for the granted UL transmission.

The benefit of the flag is to potentially reduce overhead for indicating UL precoder (e.g., TPMI). Once the NW receives DL/UL CSI in a UL-related report, the NW can choose/determine whether a precoder recommendation associated with the reported CSI (or UL TPMI) can be used or not from the UE. If NW determines to follow the precoder recommendation, NW can include a flag in a UL-grant DCI to inform that the UE designs the UL precoder associated with the reported CSI (or UL TPMI), without indicating the precoder in a legacy way (e.g., TPMI in NR).

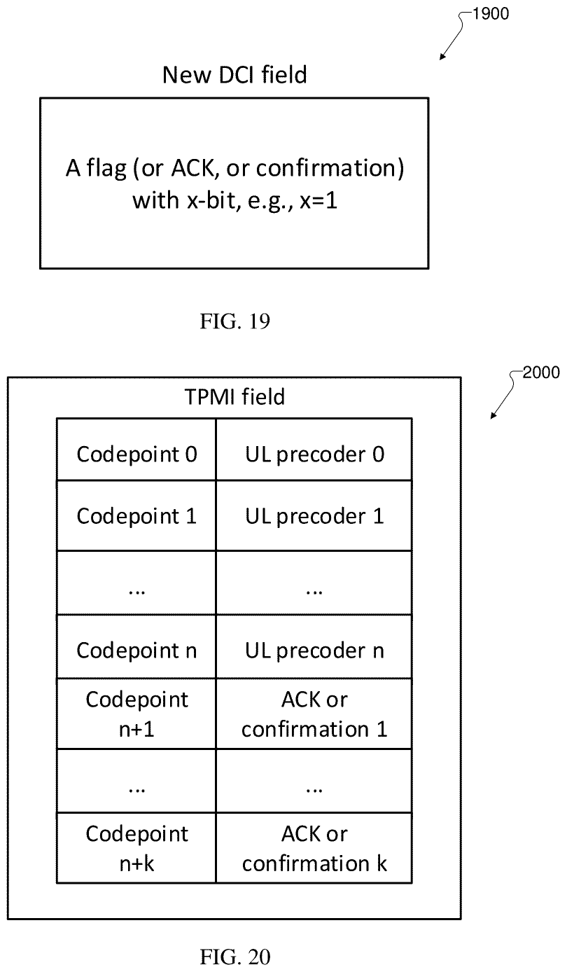

FIG. 19 illustrates an example of indicating a flag via a new UL DCI field 1900 according to embodiments of the present disclosure. This example is for illustration only and other embodiments can be used without departing from the scope of the present disclosure.

In one example, as shown in FIG. 19, a flag (or ACK) is included in a new UL-DCI field/format to indicate that the NW follows (or not follow) a precoder recommendation associated with the reported CSI (or UL TPMI) from the UE.

In one example, a flag is included/incorporated in an existing UL-DCI field/format to indicate that the NW follows (or not follow) a precoder recommendation associated with the reported CSI (or UL TPMI) from the UE.

In one example, a flag is included in an unused codepoint of an existing UL-DCI field/format to indicate that the NW follows (or not follow) a precoder recommendation associated with the reported CSI (or UL TPMI) from the UE.

In one example, a flag (or ACK) is indicated via a new UL-DCI field, which is separated from an existing field (e.g., TPMI field) as shown in FIG. 19.

FIG. 20 illustrates an example of indicating a flag via an existing UL DCI field 2000 according to embodiments of the present disclosure. This example is for illustration only and other embodiments can be used without departing from the scope of the present disclosure.

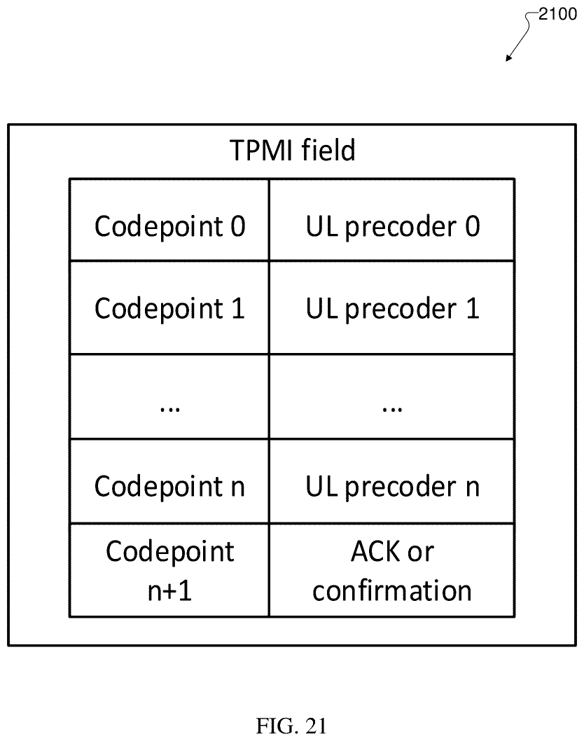

FIG. 21 illustrates another example of indicating a flag via an existing UL DCI field 2100 according to embodiments of the present disclosure. This example is for illustration only and other embodiments can be used without departing from the scope of the present disclosure.

In one example, as shown in FIG. 20, a flag (or ACK) is indicated via an existing UL-DCI field, e.g., TPMI field, with (additional) k extra codepoints or with utilizing k unused/reserved codepoints. In one example, k=1. In one example, k>1. When one of the codepoints indicating an ACK (or flag) is signaled/indicated, the UE designs/uses UL precoder associated with the reported TPMI in the (latest) UL-related report.

In one example, the case of k>1 can correspond to a scenario where multiple (k) TPMIs are reported and one of them can be indicated via the k codepoints.

In one example, the case of k>1 can correspond to a scenario where one TPMI is reported but multiple (k) precoder candidates can be generated using one TPMI, and one of them can be indicated via the k codepoints.

Another example, as shown in FIG. 21, is for k=1.

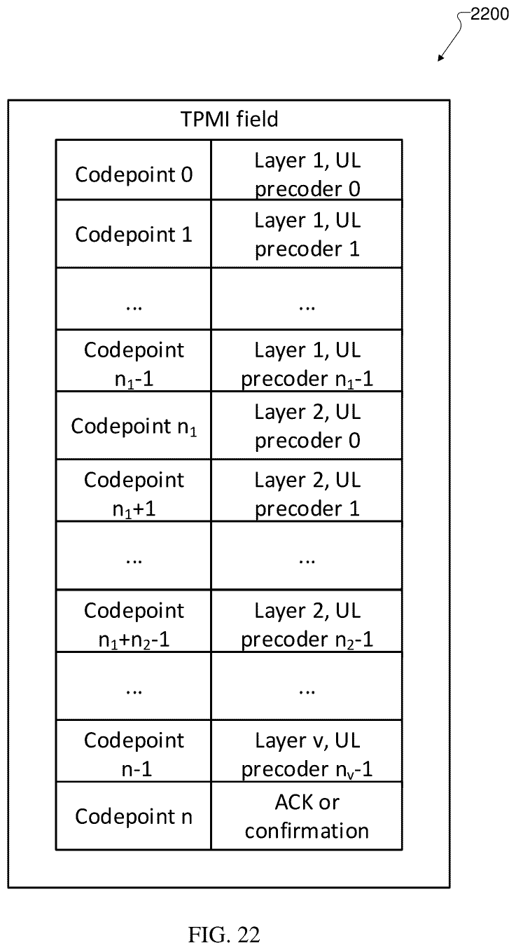

FIG. 22 illustrates yet another example of indicating a flag via an existing UL DCI field 2200 according to embodiments of the present disclosure. This example is for illustration only and other embodiments can be used without departing from the scope of the present disclosure.

As shown in FIG. 22, another example is for k=1, where the TPMI field indicates a layer index and UL precoder jointly, and n=Σnᵢ.

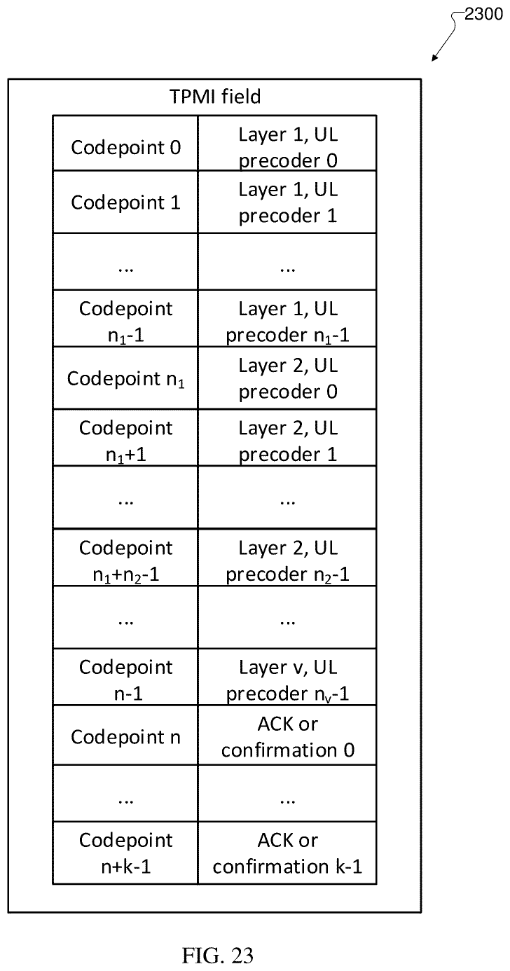

FIG. 23 illustrates still another example of indicating a flag via an existing UL DCI field 2300 according to embodiments of the present disclosure. This example is for illustration only and other embodiments can be used without departing from the scope of the present disclosure.

As shown in FIG. 23, another example is for k>1, where the TPMI field indicates a layer index and UL precoder jointly, and n=Σnᵢ.

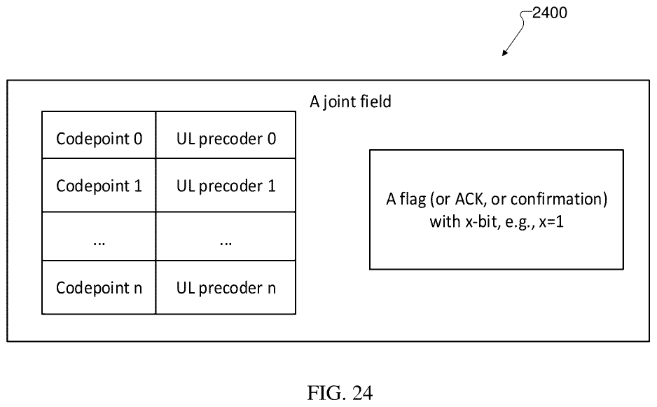

FIG. 24 illustrates an example of indicating a flag via a joint indicator 2400 according to embodiments of the present disclosure. This example is for illustration only and other embodiments can be used without departing from the scope of the present disclosure.

As shown in FIG. 24, in one example, a flag (or ACK) is indicated via a joint indicator incorporating with an existing UL-DCI field, e.g., TPMI field.

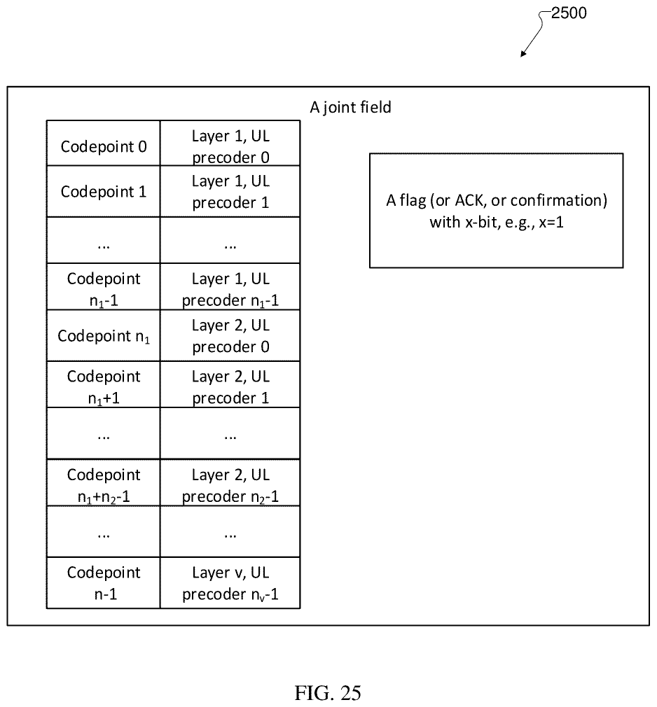

FIG. 25 illustrates another example of indicating a flag via a joint indicator 2500 according to embodiments of the present disclosure. This example is for illustration only and other embodiments can be used without departing from the scope of the present disclosure.

As shown in FIG. 25, a flag (or ACK) is indicated via a joint indicator incorporating with an existing UL-DCI field, e.g., TPMI field. In this example, the TPMI field indicates a layer index and UL precoder jointly, and n=Σnᵢ.

In one example, when the UL-related report includes UL CSI (UL TPMI) or precoder or DL CSI or DL precoder, the NW/gNB, upon reception of the UL-related report, can accept the reported UL CSI or precoder (UL TPMI), or DL CSI or DL precoder for upcoming UL transmission(s) (e.g. via DCI with UL-grant for PUSCH transmission). The UL-grant includes UL resource allocation (UL RA), i.e., a set of PRBs for UL transmission and an acknowledgement (ACK) or confirmation for the received UL CSI (UL TPMI) or precoder or DL CSI or precoder.
In one example, the ACK can be via a 1-bit field in the DCI carrying the UL-grant. This 1-bit field can be replaced by a TPMI field or can be included in a new field in addition to a TPMI field. When only one of the 1-bit field and the TPMI field can be present in the DCI, then a higher layer (e.g. RRC) or MAC CE indication can be used to indicate the presence of one of the two. When both the 1-bit field and the TPMI field can be present in the DCI, then when the 1-bit field indicates ACK, the TPMI field can be ignored by the UE or reserved (not used), otherwise (when the 1-bit field indicates NACK), the TPMI field overrides the reported CSI and indicates the UL precoder for the UL transmission(s).
In one example, the ACK can be via a codepoint of the TPMI field in the DCI carrying the UL-grant. For example, when the codepoint=0, it corresponds to ACK, otherwise it corresponds to an UL TPMI value.
In one example, the ACK can be implicit (without any field in DCI). For instance, UL TPMI field can be absent from the UL-DCI. When absent, it acts as an implicit ACK. When present, the UL TPMI is provided via the UL-DCI. The information whether UL TPMI field is absent or present can be higher layer configured (via a separate RRC parameter or a part of the CSI trigger state definition) or indicated via MAC CE or DCI. When DCI is used, a two-stage DCI can be used, where the stage 1 of the DCI indicates the information about present/absence of UL TPMI, and when present, UL TPMI is indicated via the stage 2 of the DCI.
In one example, a two-stage DCI can be used, where the stage 1 of the DCI includes the ACK to indicate whether the UE uses the precoder associated with the reported CSI or not, and UL TPMI is indicated via the stage 2 of the DCI if NACK is signaled in the first stage of the DCI.

In this disclosure, ACK or a flag or a confirmation information can be used interchangeably. Although we use one of those terminologies in the disclosure, it can be described under another name or terminology.

In one example, a flag can be layer-common, i.e., one for all layers. For example, for rank-v precoder, one-bit indicator can be used for the flag, where the bit indicates whether the UE designs UL precoder associated with the reported CSI (or UL TPMI) or not for all layers. In another example, an unused codepoint(s) of an existing DCI field can be used for the flag, whether the UE designs UL precoder associated with the reported CSI (or UL TPMI) or not for all layers.

In one example, a flag can be layer-specific, i.e., one for each layer. For example, for rank-v precoder, a v-bit bitmap indicator can be used for the flag, where a i-th bit (counted from LSB or MSB) indicates whether the UE designs UL precoder associated with the reported CSI (or UL TPMI) or not for the corresponding layer i. In another example, a combinatorial indicator can be used for the flag to indicate L layers among the v layers to inform that the UE designs UL precoder associated with the reported CSI (or UL TPMI) for the indicated L layers. In this case, a payload of the indicator can be given by bit.

$$⌈ {log}_{2} ( \begin{matrix}v \\ L\end{matrix} ) ⌉$$

In one example, a flag can be SB-specific, i.e., one for each SB, where the granularity of SB is a RBG, a RB, a subcarrier, a multiple of RBGs, a multiple of RBs, or a multiple of subcarriers. For example, for K SBs, a K-bit bitmap indicator can be used for the flag where a i-th bit (counted from LSB or MSB) indicates whether the UE designs UL precoder associated with the reported CSI (or UL TPMI) or not for the corresponding SB i. In another example, a combinatorial indicator can be used for the flag to indicate X SBs among the K SBs, to inform that the UE designs UL precoder associated with the reported CSI (or UL TPMI) for the indicated X SBs. In this case, a payload of the indicator can be given by

$$⌈ {log}_{2} ( \begin{matrix}K \\ X\end{matrix} ) ⌉$$

bit. In another example, a starting SB index S and a number of length L are indicated to the SBs on which the UE designs the UL precoder associated with the reported CSI. In this case, the UE designs the UL precoder for the SB S, SB S+1, . . . , and SB S+L−1. In one example, S can be indicated by a ┌log₂ K┐-bit indicator. In one example, L can be indicated by a ┌log₂ K┐-bit indicator.

In one example, a flag can be SB-common, i.e., one for all SBs or WB. For example, for K SBs, one-bit indicator can be used for the flag, where the bit indicates whether the UE designs UL precoder associated with the reported CSI (or UL TPMI) or not for all SBs. In another example, an unused codepoint(s) of an existing DCI field can be used for the flag, whether the UE designs UL precoder associated with the reported CSI (or UL TPMI) or not for all SBs.

Similar to the examples above, a flag can be extended and according to at least one of the following examples.

In one example, a flag can be layer-common and SB-common, i.e., one for all SBs and all layers.

In one example, a flag can be layer-specific and SB-common, i.e., one for each layer and for all SBs.

In one example, a flag can be layer-common and SB-specific, i.e., one for each SB and for all layers.

In one example, a flag can be layer-specific and SB-specific, i.e., one for each SB and for each layer.

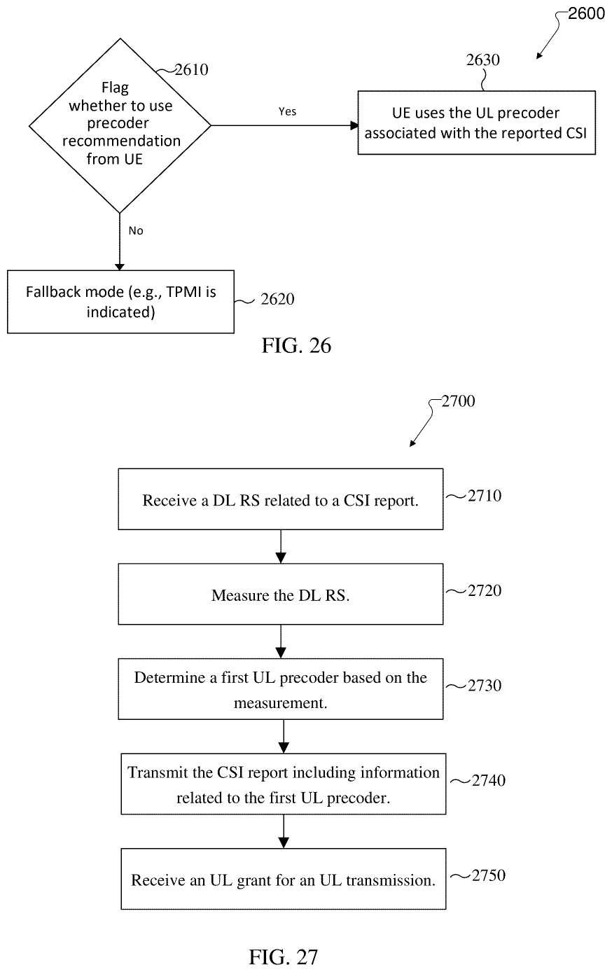

FIG. 26 illustrates an example procedure for fallback 2600 according to embodiments of the present disclosure. This example is for illustration only and other embodiments can be used without departing from the scope of the present disclosure.

As shown in FIG. 26, the procedure 2600 begins at step 2602, where a determination is made whether to use a precoder recommendation from the UE. If the precoder recommendation from the UE is not used, then at step 2604, a fallback mode is performed. If the precoder recommendation from the UE is used, then at step 2606, the UE uses the UL precoder associated with the reported CSI.

In one embodiment, a flag can indicate either a UE uses the UL precoder associated with the reported CSI (or UL TPMI) or not. When the flag indicates that the UE doesn't use/design the UL precoder associated with the reported CSI (i.e., the NW doesn't follow the precoder recommendation from the UE due to a NW's decision), a fallback mode is performed to explicitly/implicitly indicate a TPMI (indicating a (new) UL precoder) or to let the UE to design a UL precoder or a default UL precoder or to not design any precoder.

In one example, when a fallback mode is performed (i.e., the flag indicates ‘no’ as shown in FIG. 26), a TPMI is (additionally) indicated for the UE to design a UL precoder associated with the TPMI for UL transmission.

In one example, when a fallback mode is performed (i.e., the flag indicates ‘no’ as shown in FIG. 26), a default UL precoder can be designed for UL transmission, where the default UL precoder can be fixed, or configured via higher-layer signaling (e.g., RRC).

In one example, when a fallback mode is performed (i.e., the flag indicates ‘no’ as shown in FIG. 26), a UE should not design a UL precoder for UL transmission.

In one example, when a fallback mode is performed, at least one of the above examples can be utilized/applied.

In one embodiment, a UL-DCI to grant to a UE to perform UL transmission can be two-stage DCI (or two-part DCI), where a first-stage DCI of the two-stage DCI includes (hypothesis) information that determines a content of a second-stage DCI. In one example, a flag to indicate whether the UE designs UL precoder associated with the reported CSI (or UL TPMI) or not is included in the first-stage DCI.

In one example, when a flag in the first-stage DCI indicates a fallback mode, a TPMI is included in the second-stage of the two-stage DCI, where the TPMI indicates a UL precoder for UL transmission.

In one example, when a flag in the first-stage DCI indicates a fallback mode, a default UL precoder can be designed for UL transmission, where the default UL precoder can be fixed, or configured via higher-layer signaling (e.g., RRC).

In one example, when a flag in the first-stage DCI indicates a fallback mode, a UE should not design a UL precoder for UL transmission.

In one example, when a flag in the first-stage DCI indicates the UE to use the UL precoder associated with the reported CSI (or UL TPMI), a TPMI corresponding to the UL precoder is not included either in the first-stage DCI or in the second-stage DCI.

In one embodiment, the UE uses/designs UL precoder associated with a UL-related report, where (the last symbol of) the time instance of the UL-related report is before (the first symbol of) the time instance of a flag is signaled via DCI.

In one example, the UE expects to receive the network's response, a flag or ACK no earlier (or later) than X symbols/slots after the last symbol/slot of transmitting the UL-related report.

If the UE does not receive the network's response (ACK/NACK) according to the timing assumption, the corresponding UE's behaviors—e.g., re-transmitting the UL-related report a configured number of times before dropping.

Any of the above variation embodiments can be utilized independently or in combination with at least one other variation embodiment.

FIG. 27 illustrates an example method 2700 performed by a UE in a wireless communication system according to embodiments of the present disclosure. The method 2700 of FIG. 27 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2700 is for illustration only and other embodiments can be used without departing from the scope of the present disclosure.

The method 2700 begins with the UE receiving a DL RS related to a CSI report (2710). The UE then measures the DL RS (2720). The UE then determines a first UL precoder based on the measurement (2730). The UE then transmits the CSI report including information related to the first UL precoder (2740).

The UE then receives an UL grant for an UL transmission (2750). For example, in 2750, the UL grant includes a flag that indicates whether the UL transmission is based on the first UL precoder. In various embodiments, the flag is indicated via an 1-bit indicator of an UL-DCI field. In various embodiments, the flag is indicated via a codepoint of an UL TPMI field.

In various embodiments, the UL grant is included in a two-stage DCI and a first-stage DCI of the two-stage DCI includes the flag. In some examples, when the flag indicates that the UL transmission is based on the first UL precoder, a second-stage DCI of the two-stage DCI does not include an UL TPMI field. In some examples, when the flag indicates that the UL transmission is not based on the first UL precoder, a second-stage DCI of the two-stage DCI includes an UL TPMI field. The UL TPMI field indicates a second UL precoder for the UL transmission.

In various embodiments, when the flag indicates that the UL transmission is not based on the first UL precoder, the UE utilizes a default precoder or does not utilize any precoder. The default precoder, if utilized, is fixed or configured via RRC signaling.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive a downlink reference signal (DL RS) related to a channel state information (CSI) report; and
a processor operably coupled to the transceiver, the processor configured to:
measure the DL RS, and
determine a first uplink (UL) precoder based on the measurement,
wherein the transceiver is further configured to:
transmit the CSI report including information related to the first UL precoder, and
receive an UL grant for an UL transmission,
wherein the UL grant includes a flag, and
wherein the flag indicates whether the UL transmission is based on the first UL precoder.

2. The UE of claim 1, wherein the flag is indicated via an 1-bit indicator of an UL-downlink control information (DCI) field.

3. The UE of claim 1, wherein the flag is indicated via a codepoint of an UL transmit precoding matrix indicator (TPMI) field.

4. The UE of claim 1, wherein:
the UL grant is included in a two-stage downlink control information (DCI), and
a first-stage DCI of the two-stage DCI includes the flag.

5. The UE of claim 4, wherein, when the flag indicates that the UL transmission is based on the first UL precoder, a second-stage DCI of the two-stage DCI does not include an UL transmit precoding matrix indicator (TPMI) field.

6. The UE of claim 4, wherein:
when the flag indicates that the UL transmission is not based on the first UL precoder, a second-stage DCI of the two-stage DCI includes an UL transmit precoding matrix indicator (TPMI) field, and
the UL TPMI field indicates a second UL precoder for the UL transmission.

7. The UE of claim 1, wherein:
when the flag indicates that the UL transmission is not based on the first UL precoder, the processor is further configured to one of utilize a default precoder or not utilize any precoder, and
the default precoder is fixed or configured via radio resource control (RRC) signaling.

8. A base station (BS) comprising:
a processor; and
a transceiver operably coupled to the processor, the transceiver configured to:
transmit, to a user equipment (UE), a downlink reference signal (DL RS) related to a channel state information (CSI) report;
receive the CSI report including information related to a first uplink (UL) precoder associated with the DL RS; and
transmit an UL grant for an UL reception,
wherein the UL grant includes a flag, and
wherein the flag indicates whether the UL reception is based on the first UL precoder.

9. The BS of claim 8, wherein the flag is indicated via an 1-bit indicator of an UL-downlink control information (DCI) field.

10. The BS of claim 8, wherein the flag is indicated via a codepoint of an UL transmit precoding matrix indicator (TPMI) field.

11. The BS of claim 8, wherein:
the UL grant is included in a two-stage downlink control information (DCI), and
a first-stage DCI of the two-stage DCI includes the flag.

12. The BS of claim 11, wherein, when the flag indicates that the UL reception is based on the first UL precoder, a second-stage DCI of the two-stage DCI does not include an UL transmit precoding matrix indicator (TPMI) field.

13. The BS of claim 11, wherein:
when the flag indicates that the UL reception is not based on the first UL precoder, a second-stage DCI of the two-stage DCI includes an UL transmit precoding matrix indicator (TPMI) field, and
the UL TPMI field indicates a second UL precoder for the UL reception.

14. The BS of claim 8, wherein:
when the flag indicates that the UL reception is not based on the first UL precoder, the UE one of utilizes a default precoder or does not utilize any precoder, and
the default precoder is fixed or configured via radio resource control (RRC) signaling.

15. A method performed by a user equipment (UE), the method comprising:
receiving a downlink reference signal (DL RS) related to a channel state information (CSI) report;
measuring the DL RS;
determining a first uplink (UL) precoder based on the measurement;
transmitting the CSI report including information related to the first UL precoder; and
receiving an UL grant for an UL transmission,
wherein the UL grant includes a flag, and
wherein the flag indicates whether the UL transmission is based on the first UL precoder.

16. The method of claim 15, wherein the flag is indicated via an 1-bit indicator of an UL-downlink control information (DCI) field.

17. The method of claim 15, wherein the flag is indicated via a codepoint of an UL transmit precoding matrix indicator (TPMI) field.

18. The method of claim 15, wherein:
the UL grant is included in a two-stage downlink control information (DCI), and
a first-stage DCI of the two-stage DCI includes the flag.

19. The method of claim 18, wherein, when the flag indicates that the UL transmission is based on the first UL precoder, a second-stage DCI of the two-stage DCI does not include an UL transmit precoding matrix indicator (TPMI) field.

20. The method of claim 18, wherein:
when the flag indicates that the UL transmission is not based on the first UL precoder, a second-stage DCI of the two-stage DCI includes an UL transmit precoding matrix indicator (TPMI) field, and
the UL TPMI field indicates a second UL precoder for the UL transmission.
